(19) United States
(12) Patent Application Publication
(10) Pub. No.: US 2002/0035559 A1
(43) Pub. Date: Mar. 21, 2002

(54) System and method for a decision engine and architecture for providing high-performance data querying operations

(76) Inventors: William L. Crowe, Leawood, KS (US); Richard H. Gumpertz, Leawood, KS (US); Brett A. Johnson, Leawood, KS (US)

Correspondence Address: SHAW PITTMAN, 1650 Tysons Boulevard, McLean, VA, 22102, US

(21) Appl. No.: 09/888,433

(22) Filed: Jun. 26, 2001

Related U.S. Application Data
(60) Provisional application No. 60/214,000, filed on Jun. 26, 2000.
(60) Provisional application No. 60/221,545, filed on Jul. 28, 2000.
(60) Provisional application No. 60/240,071, filed on Oct. 16, 2000.
(60) Provisional application No. 60/287,013, filed on Apr. 30, 2001.

(51) Int. Cl. G06F 17/30

(52) U.S. Cl. 707/2; 707/201

(57) ABSTRACT

A high performance decision engine comprising a core kernel and a plurality of user-selectable plug-in components and a schema defining table and data structures, all of which are compiled into an application. Tables within the compiled application are linked to other tables in a manner such that deterministic queries are rapidly processed by the decision engine according to a traversal scheme defined by the links between tables.

This application claims the benefit of U.S. Provisional Application No. 60/214,000 filed Jun. 26, 2000, U.S. Provisional Application No. 60/221,545 filed Jul. 28, 2000, U.S. Provisional Application No. 60/240,071 filed Oct. 16, 2000, and U.S. Provisional Application No. 60/287,013 filed Apr. 30, 2001, all of which are herein incorporated by reference in their entirety.

### BACKGROUND

1. Field of the Invention

The present invention relates generally to database systems and more particularly, the present invention relates to construction and execution of computing engines that respond to queries by processing decision-tree logic that is driven by changeable data while providing: (1) rapid response to queries, (2) accuracy, (3) reliability and availability, and (4) rapid construction and adaptability.

2. Background of the Invention

General-purpose database software may be used to support custom decision-tree programs, but performance is generally poor because of the overhead of passing data back-and-forth between the decision-tree program and the database software. Solutions based upon off-the-shelf databases achieve availability and reliability with complex software for replication, conflict resolution, recovery techniques, and some form of reliable store-and-forward message delivery. These systems are often more complex than the problem domain in which they reside. The price of this complexity can be measured in any one or all of the following areas: configuration, management, performance, and usage of the resulting system. Furthermore, while conventional database systems do incorporate data replication strategies, the conventional replication and data synchronization systems do not provide extremely high performance as required in query-intensive applications. In many database systems, replication allows conflicts to occur and then attempts to resolve the conflicts. This method for managing conflicts is neither efficient nor foolproof. Once a conflict arises, system resources are consumed attempting to fix the problem rather than being used for handling routing requests.

Alternatively, custom data structures and corresponding software for accessing those structures may be used to support custom decision-tree programs, but development time can be very high due the complexity of implementing custom data structures and operations that also include mechanisms such as indexing and search algorithms, data updates, synchronization of updates within transactions, automatic recovery from failures, data backup and restore, data replication and synchronization between similar computing platforms, etc. Modification of decision-tree logic implemented in this manner is also complex and time-consuming for similar reasons.

The following sections further elaborate on the problems associated with use of conventional general purpose databases to provide high-performance decision-tree analysis.

1. General Purpose Databases Are Optimized for General Purpose Problems

Conventional databases are designed for general purpose problems which are addressed using ad hoc queries. An ad hoc query is any query of the data formulated to retrieve specific data based on some criteria. Ad hoc queries, as the name implies, can be used to access data wherever it may be stored in one or more tables within the database without the need for pre-defined criteria. That is, an ad hoc query can be a completely novel query tailored for unique data retrieval requirements. In conventional relational databases a user submits a query using some query language, such as structured query language (SQL). An example of an ad hoc query may request information such as: select name from the NAMES table, an address from the ADDRESSES table, and a phone number from the PHONE_NUMBERS table, such that the name in the CUSTOMER table and the social security number in the SSN table equals some value. To formulate a result, a conventional database joins the data at query time, i.e., it gathers different data sets from the different tables to return a requested result. That is, in a conventional database, the query function looks through various tables, finds the associated records and returns a result that satisfies the user's request.

Complex queries may be accomplished in conventional database systems by using sub-queries in which the result of one query is used as input to another sub-query. Such sub-queries are known in the art as correlated sub-queries, which are typically performed using temporary tables. In formulating a result to the complex query, data from one sub-query is stored in a temporary table and the table is subsequently joined in the correlated sub-query. In this manner, a result satisfying each portion of the query criteria is retrieved.

In large databases, index systems are used to speed data retrieval operations. A typical database system has indexes on one or more columns that make up each table. These indexes are used during a join operation (i.e., selecting data from two or more tables based on a relationship between columns in the tables) to first get results set from one table, then work back through the other tables using these the results. As known in the art, many different query optimization algorithms can be applied, but in each case, the “joining” of tables is performed during the processing of each query, resulting in execution time being expended on finding corresponding rows in distinct tables.

The queries presented to query engines are often limited to a small set. That is, the same query is executed repeatedly with the only variation being the parameters controlling the data-selection process. Furthermore, these repeating queries can be predicted in advance and the data structures and access code can be customized to improve performance of those queries, even if that requires sacrificing performance on other, ad-hoc, queries.

2. Lack of Trigger on Query Operations

Conventional databases also include a variety of “triggers” that are used to perform actions within the database based upon the operation being performed. Examples of commonly implemented triggers include ones that act upon data-insert operations, data-update operations, and data-deletion operations. Such triggers are only associated with data-manipulation operations. That is, they are used only when data is being added, deleted or modified. Conventional databases do not include triggers that will execute during query operations. When a user selects data from the various tables, the query engine gathers the data and returns a result to the user. No further action is taken within the database system. To accomplish further action, other programming applications would have to be incorporated into the application by the end-user. For example, the user (or an application program) would first have to execute a query to retrieve the information, next analyze the results and determine whether further action is warranted (i.e., whether a triggering event has taken place), and, finally, go back into the database to retrieve additional data and/or make changes to the data. As a consequence, multiple steps are required to complete an operation in response to a query. This results in slower performance.

3. Data Structures Are Interpreted, Not Compiled

The programming code for conventional database systems is not changed when a new table is defined. Accordingly, the database code cannot directly access the fields of a table. Instead, the database system must maintain, for each defined table, meta-information describing that table. Whenever a value is required from the table, this meta-information is consulted first, to determine how to access the data stored in the table. This interpretation of meta-information slows down access to the data.

4. Reads Not Optimized

General-purpose database systems are not optimized for “read-mostly” applications, i.e., applications in which most of the accesses to the data only read the data and do not change it. Because of their general purpose nature, conventional database systems are typically unable to use simpler and faster access methods for reads-only operations. As a result, locking and other consistency-oriented overhead are associated with both read and write operations, although for a read-mostly application, such overhead is only needed during the relatively less frequent writes.

5. Non-Native Query Protocols

Conventional databases are accessed using an interface defined as part of the product design. To implement a query-based application that supports other query protocols, several layers of decoding and encoding are typically required in both the application and the database. For example, in the application must first decode an incoming query from the user of the application then it must encode a corresponding database query. Next, the database must decode the database query, then encode the database response. Next, the application decode the database response and, if necessary, send subsequent queries to the database for processing until a response to the user's query is fully computed. Finally, the application must encode the response to the user of the application. These multiple levels of decoding and encoding, especially if repeated a significant number of times slow down overall response time.

Among the many systems requiring high-performance decision-tree functionality, data structures and software used in conventional telephony systems illustrate the problems described above. For example, conventional telephone switches have employed the custom code and data-structure approach. This has tended to result in rigid service control logic (routing tables) that can be modified only with significant changes to the programming of the switch, resulting in expensive changes that involve significant delay from concept to delivery. Furthermore, only the manufacturer of the switch has had the ability to perform such changes.

In response to this problem, soft-switch technologies have been developed that separate service-control logic from other portions of the switch. In some soft-switches, general-purpose databases have been included in the product design in an attempt to increase flexibility and adaptability. Unfortunately, so doing has also significantly decreased performance because these general-purpose databases are not adapted to the read-mostly environment as described above.

In light of these and other problems related to implementing high-performance decision-tree system such as required for many telephony and other applications, a need exists for database architectures, systems and methods designed for such special-purpose applications.

### SUMMARY OF THE INVENTION

Without restricting the applicability of the invention, many examples of application areas in which this invention is useful are related to telephony and voice-over-data networking. Among these are the following: Routing and Translation Engines; SIP (Session Initiation Protocol) Redirection Servers; SIP Location Servers; and SCP (Service Control Point) Adjunct Processors.

Common to many of the applications listed in Paragraph [0017] are the following requirements, among others: rapid query processing and response; rapid implementation and deployment of the software; easy integration with existing (legacy) systems; easy integration with a variety of network management systems (including logs, alarms, and measurement); support for a variety of communication protocols for queries; control of decision-tree logic using data provided in the query; control of decision-tree logic using stored data; provisioning of stored data while continuing to process queries; support for parallel execution within a multi-processor computing platform; support for parallel execution across multiple computing platforms; and support for high-availability.

The current invention gives the performance of custom-code solutions without sacrificing the flexibility of database-oriented solutions. The invention meets the above-described requirements of decision engines with the following features: generating application-specific database tables/wrapping application-specific databases around applications; “pre-joined” tables using successors; execution of programmed actions during table traversal (query triggers); automated generation of table-traversal code from high-level descriptions; automated generation of query-protocol code from high-level descriptions; automated generation of temporary data structures from high-level descriptions; automated generation of persistent data structures from high-level descriptions; automated generation of provisioning code for persistent data structures; common persistent-data provisioning mechanisms that include appropriate locking, transactions, backup, etc.; and dynamic configuration and loading of modules that plug into a kernel.

The decision engine-cluster architecture provides seamless scalability from single to multiple decision engine system configurations. Routing clients can request routes and provisioning agents can provision the cluster from any element in the cluster. In the case of a cluster element failure, the external client or agent simply connects to another cluster element and continues where it left off. A decision engine-cluster uses conflict avoidance technologies to achieve continuous routing availability while greatly simplifying transparent synchronized cluster provisioning.

The decision engine-cluster provisioning architecture is equally applicable to the synchronized distribution of routing and non-routing data provisioning. A comprehensive system provisioning architecture is created by extending the information model beyond dial-plan/routing data to include provisioning data such as link data, trunk circuit mapping, and operational configuration. Clients register with the cluster for relevant data updates through the Exporter interface, which is transparent to whether cluster elements are running local or remote. Using the Exporter feature of the decision engine-cluster, information model extension, and existing framework functionality, a comprehensive system provisioning architecture can be realized in a fraction of the time and cost of alternative approaches.

### BRIEF DESCRIPTION OF THE DRAWINGS

FIG. 1 is a conceptual diagram showing the components used in a software architecture implemented in an embodiment of the present invention.

FIG. 2 is a more detailed view of some components that may be included in an embodiment of the present invention.

FIG. 3 is a schematic diagram showing an application development environment used to implement an embodiment of the present invention.

FIG. 4A is a schematic flow diagram showing the processing steps used in a conventional data operation.

FIG. 4B is a schematic flow diagram showing the processing steps used in an embodiment of the present invention to answer the same query as shown in FIG. 4A.

FIG. 5 is a schematic flow diagram showing the input/output subsystem implemented in an embodiment of the present invention.

FIG. 6A is a schematic diagram showing a threading model implemented in an embodiment of the present invention.

FIG. 6B is a schematic diagram showing another threading model implemented in an embodiment of the present invention.

FIG. 7 is a schematic diagram showing steps involved when a decision engine is invoked and how tables are traversed in an embodiment of the present invention.

FIG. 8 is a an exemplary keyless table according to the present invention.

FIG. 9 is an exemplary keyed table according to the present invention.

FIG. 10 is a schematic flow diagram showing how keyless tables are traversed in an embodiment of the present invention.

FIG. 11 is a schematic flow diagram showing how keyed tables are traversed in an embodiment of the present invention.

FIG. 12 is a schematic diagram illustrating other features of a schema table used in an embodiment of the present invention.

FIG. 13 is a schematic diagram showing the multiple routing paths, i.e., n-way routing, used in a preferred embodiment of the present invention.

FIG. 14 is a schematic diagram illustrating how continuous routing is accomplished in a preferred embodiment of the present invention.

FIG. 15 is a schematic diagram of the rollforward segment used in a preferred embodiment of the present invention.

FIG. 16 is a schematic diagram showing the master replicator used in a preferred embodiment of the present invention.

FIG. 17 is a schematic diagram showing the slave reactor used in a preferred embodiment of the present invention.

FIG. 18 is a schematic diagram showing the exporter system implemented in a preferred embodiment of the present invention.

FIGS. 19A and 19B are schematic diagrams showing the exporter system integrated within the decision engine server, and separated from the decision engine server, respectively.

FIG. 20 is a schematic diagram showing a decision engine-cluster implementing a proxy exporter.

FIG. 21 is a schematic diagram showing an architecture implementing a decision engine in support of a billing process for a wireless service provider.

FIG. 22 is a schematic diagram showing tables used in a decision engine in support of a billing process for a wireless service provider.

FIG. 23 is a schematic diagram showing the message protocol processed in a decision engine in support of a billing process for a wireless service provider.

FIG. 24 is a schematic diagram showing the context used in a query provided to a decision engine in support of a billing process for a wireless service provider.

FIG. 25 is a schematic diagram showing the steps for including and processing state information in an embodiment of the present invention.

### DETAILED DESCRIPTION OF THE INVENTION

Overview

The invention provides a system, architecture and method to generate high performance, flexible, and scaleable table-driven decision engines. It is a framework that consists of a core kernel component and plug-ins that define the table schemata, request transports and protocols, and provisioning interfaces. The decision engine of the present invention joins data within multiple tables at the time the data is added. That is, the decision engine comprises a plurality pre-joined tables wherein the links between tables are formed at provision-time rather than during the query execution process.

The present invention is suitable for implementation in any data environment requiring maximum query processing speed, and where typical queries are well-known. For example, the decision engine may be beneficially implemented in numerous telephony and/or other routing problems because the such systems can employ a deterministic querying model. That is, in these situations, the same type of information is routinely queried with a limited set of input data resulting in a deterministic output. For every well-formed (i.e., complete) query, there is only one correct result (or set of results). Of course, this does not preclude use of non-deterministic approaches, such as implementing a random number generator to select between equally good results. However, once the choice is made, the query, now comprising the randomly selected criteria, still has only one proper result. Said another way, in essence, the answers to every possible query are pre-formed inside of the database. So, when a user submits a query, the answer to the question is readily determined.

By implementing a decision engine according to the present invention, the performance benefit is orders of magnitude faster than found in conventional databases. To effectively pre-form the answers to questions, the questions need to be known up-front. It would not be practical to pre-form the answers to an arbitrarily large number of questions. Accordingly, for maximum benefit from the present invention, a decision engine is designed in accordance with the specifications of the actual problem. That is, the decision engine designer should know which questions will be posed by a given application. This information is used to pre-form the answers to just those questions within the decision engine.

In cases where there are numerous, or even infinite possibilities for queries presented, the present invention may still be advantageously implemented to process those queries that are most commonly executed. That is, if a particular problem is such that, e.g., 70% of the queries can be modeled in a deterministic fashion, while the other 30% require ad hoc querying capabilities, a decision engine according to the present invention could be implemented to process the 70% of the queries while a conventional database could be used to handle the remaining 30%.

Once the questions are known, a decision engine structure can be implemented using generation technology, as described herein. In a preferred embodiment, the decision engine is designed from scratch. That is, the problem is formulated in terms of metadata, for example using an extensible markup language (XML). In this manner questions and the logic needed to execute the answers to those questions can be easily coded in a higher-level programming language, such as, e.g., C++. The XML statements can be processed by a code generator to create the decision engine, which includes processing logic as well as the data itself.

The present invention was formerly referred to as the Pathfinder and Pathways technologies in the earlier provisional patent applications, already herein incorporated by reference. While present invention may still be referred to in that manner, the decision engine, the database, and the technology are also referred to herein as “Preform,” “Preform application,” “Preform engine,” or “Preform database” or simply as a “data-engine,” “decision-engine,” or “decision-engine cluster.”

In one embodiment of the present invention, a novel database trigger is provided. Database triggers are currently known in the art, but only for limited events. That is, in conventional database systems, triggers are only associated with inserts, updates, deletes, and data provisioning. In contrast, according to the present invention, in addition to associating actions with the process of inserting or manipulating data, triggers can be associated with query operations. That is, the very process of querying the database can result in further action being automatically performed by the decision engine. Actions may include, for example, recording the number of times a certain type of query was issued, manipulating the data requested or examined by the query operation, and even manipulating data not touched by the query. Other examples include, changing the path the queries traverses, such that, for example, the result varies based on the time of day, day of the week, or some other criteria.

Implementing query triggers according to the present invention allows the user or application to accomplish a given task in one step. Accordingly, the present invention eliminates the round trips and breaking-up of programming logic as is necessary in conventional databases. In another example, a query trigger could result in generation of a random number that can be used to select the next action to be taken.

The present invention is well suited to the telephony industry because, in that industry, programming logic is typically executed when calls are being set up in the network. For example, when a caller dials a certain number of digits, and if the caller has certain services enabled, the network may have to perform some database look ups. Additionally, among other tasks, the network may have to perform load balancing on the network by spreading traffic over different trunk groups. In each case, the speed with which the network can perform these tasks and set up a call is critical to providing useful services for customers. Because the decision engine and architecture of the present invention provide much faster results than can be achieved with conventional database systems it is an ideal solution for the telephony industry. However, there are many other arenas in which rapid database query execution is desirable, including, but not limited to postal and shipping operations, customer service/order processing operations, and the like.

The present invention is extremely well suited for telephony applications because the questions presented typically have only one answer as described above. That is, when a telephone network performs a query for routing instructions, typically, the result yields a single next step. If subsequent routing is required, subsequent queries are made. The general question presented in many telephony applications is: How should this call be routed, given, e.g., the calling number, called number, time-of-day, etc.? Based on this input criteria, a specific route is returned. Although the capability of determining a specific (and singular) result is important for telephony, it is not core the present invention. That is, the decision engine of the present invention could return multiple answers, or sets of results, if the particular application were designed in that manner. However, as with telephony applications, if identical input is provided to the query, the decision engine will return the same set of results, unless some other randomness implemented, as noted above.

As described above, the present invention comprises systems and methods for pre-formed joins resulting in preformed answers to various questions. To accomplish this, the decision engine itself is aware of the application. That is, the decision engine “knows” what kind of questions are going to be asked and what kind of logic is going to be executed. Accordingly, in the present invention, instead of building software around a relational database product, the decision engine and database are the framework in which the application is built. This design method completely inverts the conventional database application development process. In the present invention, the design process includes creation of a metadata description of the problem. As used herein, metadata means any suitable format for defining the problem and solution structure in a manner that can be compiled into a computer program. In a preferred embodiment of the present invention, the metadata comprises XML-based descriptions of the questions that are going to be asked and the logic needed to answer them. The metadata is used to generate code, that, when compiled and executed, forms the application and the database.

The present invention comprises, not only the data from multiple tables pre-joined to form a complete object, the data can also comprise instructions, i.e., embedded applications can be stored and acted upon as required. The programming logic and data are merged within the decision engine resulting in a high performance querying system.

Embedded applications in the decision engine are distinct from query triggers in that the latter provides a method by which the application programmer can insert code directly into a query. Embedded applications, on the other hand, comprise that inserted code plus any other code comprising an application. For example, a common application might be made up of customer protocols defining how one presents a query, query triggers defining what actions are performed during the query, interfaces to one or more back-end provisioning systems defining how data is inserted, modified or deleted by the application, a custom management interface allowing the back-end systems to access the data, and some type of state management system defining how to track and manage updates across multiple systems.

The present invention implements a code generator capable of receiving input directly from a database modeling system and outputs the physical code that implements the decision engine. Accordingly, the present invention allows developers to bypass interpreting the data with a scripting engine, as is required in conventional database systems.

Another feature provided by an embodiment of the present invention is directed to ensuring high performance and reliability of the decision engines. Because the present invention is not a general purpose database certain concessions can be made to maximize query performance, with less emphasis on other data operations such as inserts, updates and deletes. Having made that design decision, the present invention is focused on queries, not on provisioning. Accordingly, the present invention reflects design decisions that simplify the conventional database replication processes. The replication processes of the present invention are referred to as “Clustering technologies.” The resulting clustering technologies are very simple, very stable, very easy to understand and it becomes a data forwarding problem as opposed to a data integrity problem. The replication solution of the present invention can be used by any application that is query-centric, i.e., an application valuing query speed over other database operations.

The present invention extends the notion of protocols, which are commonly used in telephony and data communications applications because of their efficiency, and implements capability for native processing of various transport and application protocols within the decision engine. This architecture provides greatly enhanced performance because it eliminates the need for the interpreting the protocols before instructions or data can be accessed by the decision engine. The result is a decision engine that handles communications at a protocol level which has heretofore not been used for database systems. Moreover, the present invention can be implemented using any protocol, such as those already known in the telephony arts, as well as those known in other arts.

Because the present invention is not a general purpose database, it may not be suitable for every data application. However, if there is a well defined query, such as is common in telephony, the decision engine works very well. Other applications where decision trees are applicable could be suitable as well, provided that the decision trees are driven by large sets of data. Telephony is particularly well suited because of the performance requirements of such systems.

Another application that may be benefited by the present invention is that of providing web-interfaces. From a web standpoint, if an application performs the same query over and over again, the present invention could beneficially implemented. A catalog search would be an example of such. Although conversion of existing database systems in order to use the present invention may require some effort to re-write the code, it may still be beneficial. To simplify the development effort, the most common queries could be implemented in pre-form first.

The decision engine of the present invention need not be in direct competition with conventional database providers. That is, as described above, conventional databases excel at providing ad hoc queries. The present invention, on the other hand, excels at providing fast results for pre-defined queries. Accordingly, the present invention may be implemented along side of conventional database systems. To accommodate such configurations an embodiment of a decision engine allows data feeds into the system which can be received in many formats. For example, a user could implement a conventional database, such provided by Oracle. When ad hoc queries or database updates are made, the user could use any tools provided by Oracle. A decision engine of the present invention, can be set up to receive a data feed from Oracle using a provisioning plug-in. Users that need the high performance queries would use the decision engine, instead of Oracle, to retrieve the data needed. Those same users may retain Oracle for the other data management or ad hoc query operations.

An embodiment of the present invention also provides support for implementing a database of record system. A database of record is commonly used in telephony applications to preserve system integrity in the event of a catastrophic failure. For example, in a typical telephony system there is not just one centralized system for databases and application logic. There may be some data or logic in the switch, there may be some data or logic in a provisioning system, and there may be data and logic associated with customer accounts and billable usage. Each of these separate data systems all inter-feed one another with information. To avoid catastrophic loss of all data and logic, telephony operators typically designate at least one of those systems as being the database of record. That is, if everything is wiped out, there needs to be at least one database from which could the operator recover the other databases. If desired, the decision engine of the present invention may serve as the database of record.

Alternatively, a relational database could serve as the database of record. Any changes in the data are fed down to the decision engine. In this case, one could wipe out decision engine. The user could regenerate the application code from the metadata or reload the previously generated code, if available, to restore the decision engine application. Data in the decision engine could then be re-provisioned using data from the database of record. In this configuration, the database of record also serves as the ad hoc query engine and can be used to perform any data provisioning tasks.

Although in many applications, a conventional database may serve as the database of record, nothing in the present invention precludes the decision engine from serving this purpose. That is, if the application developer so desires, a decision engine according to the present invention may be run as the sole database in a system.

Architecture Used in an Embodiment of a Decision Engine

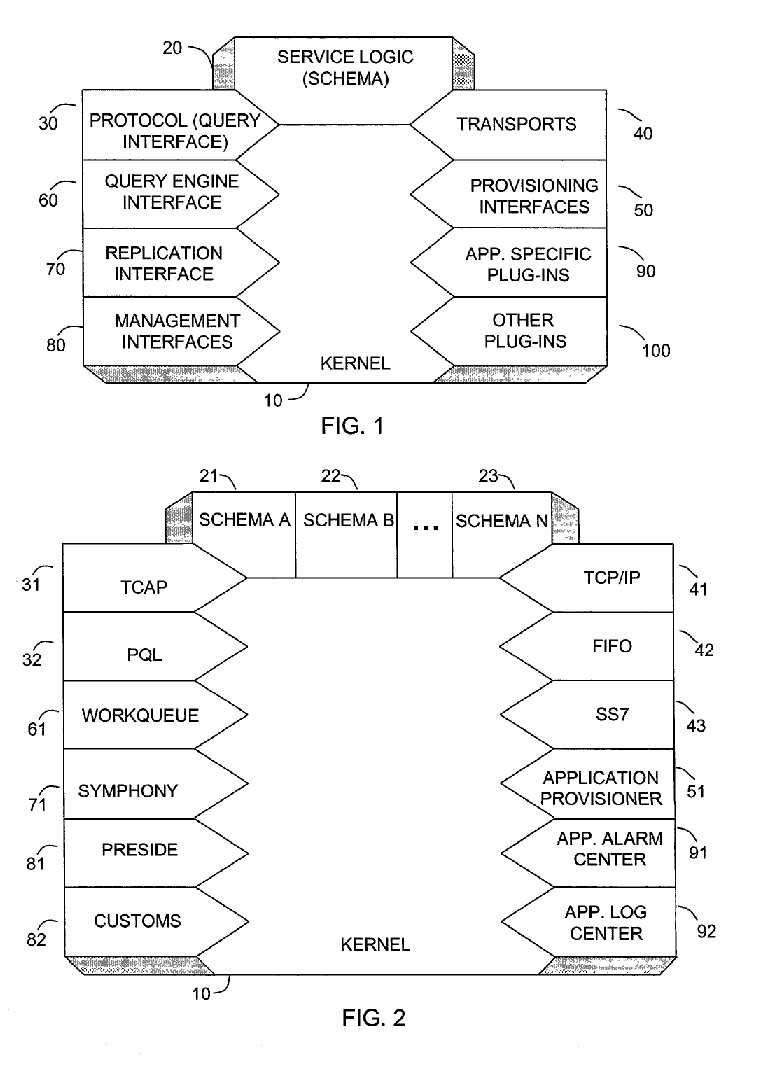

FIG. 1 is a high-level schematic diagram of an architecture used in a generic embodiment of the present invention. FIG. 2 is a more detailed schematic diagram illustrating some components that may be included in a specific embodiment of the present invention. As shown in FIG. 1, the architecture comprises kernel 10 and a plurality of user-defined plug-ins and/or user-selected standard plug-ins. Kernel 10 contains a dynamic plug-in loader and core decision engine components. When kernel 10 initializes, it dynamically loads plug-ins (shared libraries implementing well-known interfaces), which may include, e.g., service logic (schema) 20, protocol (query interface) 30, transports 40, provisioning interfaces 50, query engine interfaces 60, replication interfaces 70, and management interfaces 80. Additionally, application-specific plug-ins 90 and other plug-ins 100 may be included in a decision engine according to the present invention. Plug-ins 20-100 comprise user defined (or selected) components that perform different functions. Furthermore, each of plug-ins 20-100 may comprise a set of one or more user-defined or pre-packaged plug-ins. In some instances, multiple plug-ins of the same type can run concurrently on the decision engine. In other instances, selection or implementation of a particular plug-in type may preclude implementation of another plug-in from that group. The function of each set of plug-ins is described below.

Schema plug-in 20 defines the table structures and the provisioned table data. For example, as shown in FIG. 2, schema plug-ins 20 in a particular decision engine may comprise schema A 21, schema B 22, and so on, up to schema N 23. The schemas are generated along with other plug-ins and become part of the run-time environment of the decision engine. That is, the tables themselves are compiled and become executable objects running in memory. Further, table objects may be linked together at run-time to provide “hard-coded” paths for responding to queries.

Protocol (query interface) plug-ins 30 handle the unpacking and assembly of protocol messages read and written by transport plug-ins 40. As described below, transport plug-ins 40 facilitate the passing of messages (instructions, data, etc.) amongst users, the decision engine and external applications or data sources. In contrast, protocol plug-ins 30 allow the decision engine to process the messages (received and to be sent) according to the protocol of the application. For example, if the decision engine is incorporated in an Advanced Intelligent Network (AIN) for call processing, SS7 transport 43 may be used to receive query messages from a service control point (SCP). In this case, TCAP plug-in 31 handles unpacks the request for input into the decision engine. Then, when a response is determined, TCAP plug-in 31 handles packing and assembly of the response (in TCAP form) for transport back to the SCP via the SS7 transport. Examples of other protocol plug-ins include, but are not limited to, plug-ins for tag length value (TLV), CORBA, RMI, Cisco transports, Query, Query Trace, DBI, and the like.

In addition to unpacking and assembling query requests and responses, protocol plug-ins 30 may also provide support for user authentication, command cancellation, XML command interpretation, and other query-related operations. Like any of the other plug-ins, a query interface plug-in may be a customer defined plug-in, such as for example a third-party query interface or may be a plug-in packaged with a decision engine product. As shown in FIG. 2, the decision engine of the present invention supports multiple query interfaces concurrently. That is, for example, both TCAP plug-in 31 and pre-packaged plug-in, Preform Query Language (PQL) 32 may operate side-by-side in the same decision engine. Because these, and other plug-in components, are compiled into the decision engine, the decision engine can communicate equally well using any query interface prescribed by the user. That is, the query language interface plug-ins provide native support for any query language chosen by the user.

Transport plug-ins 40 comprise logic for transporting messages according to the transport protocols selected by a user. Transport protocols may include, e.g., TCP/IP, FIFO, SS7, ATM, UDP, and the like. Again, multiple transport plug-ins may be implemented within a single decision engine. For example, a decision engine may include TCP/IP plug-in 41, FIFO plug-in 42 and SS7 plug-in 43 as shown in FIG. 2. In this manner, the decision engine can communicate directly with any of the three different transport protocols without having to first interpret the protocol which would increase load on the system, and consequently decrease performance.

Provisioning interface plug-ins 50 implement the provisioning interface for adding, updating, deleting and querying the service-logic database. For example, application provisioner 51 may comprise a graphical user interface (GUI) for managing data provisioning operations. In another embodiment, application provisioner 51 may comprise a plug-in for provisioning via an external database of record, as previously described.

Query engine plug-ins 60 are used to implement a query engine model appropriate for a user's application. Different query engine models may employ different threading strategies, as described in more detail in a later section. Generally, the choice of a particular query engine plug-in excludes inclusion of another query engine plug-in within the same decision engine. That is, for example, because the pre-packaged query engine plug-in WorkQueue 61 is implemented in the decision engine shown in FIG. 2, a different query engine plug-in, such as a pipeline query engine plug-in would not be included in the decision engine.

Replication plug-ins 70 are used to implement data replication and conflict-avoidance strategies. One example of a replication plug-in is pre-packaged plug-in Symphony 71, shown in FIG. 2. This plug-in and others are described in greater detail in a later section. As with query engine plug-ins 60, a decision engine will typically have at most one replication plug-in 70 installed because different replication strategies will typically utilize different strategies for locking, committing, logging, rolling-up, etc.

As with all of the other plug-ins described herein, query engine plug-ins 60 and replication plug-ins 70 and need not be the pre-packaged plug-ins provided with a decision engine product. For example, the user may develop his own customized scheduler and queue according to the unique needs of a specific implementation of the decision engine.

Management interface plug-ins 80 can be used for system administration purposes. Management interface plug-ins 80 may comprise many different plug-ins, e.g., there may system monitoring plug-ins for monitoring the performance and activities of the decision engine. An example of a system monitoring plug-in is the pre-packaged Preside plug-in 81, shown in FIG. 2. Similarly, management interface plug-ins 80 may include data export plug-ins used to export data from the decision engine into a format suitable for other purposes. Customs plug-in 82 is an example of a pre-packaged plug-in that can be used for this purpose. Finally, in addition to system monitoring and data exporting plug-ins, the decision engine may include application-specific plug-ins 90 for administrative and tracking purposes. For example, application alarm center plug-in 91, application log center plug-in 92 and an application measurement center plug-in (not shown in FIG. 2) may be used to facilitate fault, configuration, accounting, performance and security requirements of the application.

Other plug-ins 100 include third-party applications integration plug-ins and other customer-selected plug-ins. One important pre-packed other plug-in available in an embodiment of the present invention is the Sandbox plug-in (not shown in FIG. 2). The Sandbox plug-in can be used to in embodiments of the present invention to provide support for an internal database of record, if one is needed. The Sandbox plug-in provides a database including features and capabilities such as fetch, add, update and delete database operations; batch processing capability; and idempotent inserts (i.e., configurable inserts). The Sandbox plug-in may also interface with other plug-ins such as, e.g., log center plug-in 92 and alarm center 91 or other application-specific plug-ins 90 or other management interface plug-ins 80. As a database of record, the Sandbox plug-in supports transactions by providing atomicity, consistency, and durability.

An architecture used in an embodiment of a decision engine, such as shown in FIGS. 1 and 2, is designed for open computing, i.e., the architecture comprises numerous “plug and play” components. Typically, when a system is designed for maximum flexibility, as in this case, it pays in the area of performance. However, flexibility and performance are achieved in the present invention by utilizing generators (avoids interpreting XML at run-time) and plug-in technology (compiled native objects that implement database tables and any interfaces which are loaded at run-time). These technologies provide high performance solutions because they run in the decision engine execution space and do not pay the penalty of protocol conversion (as seen in conventional approaches). Additionally in an embodiment of the present invention, the decision engine resides in a heterogeneous environment designed to be portable between various operating systems and compilers. This allows customers to choose between many different configurations and optimize their hardware platforms based on price versus performance.

Applications generated according to the present invention are high-performance decision engines complete with persistent data storage as well as query, provisioning, and management interfaces. They can be thought of as a special type of database application specifically focused on the evaluation of complex service logic, satisfying performance, scalability, and availability requirements of critical environments, such as, e.g., telephony networks. The focus of the applications is high speed query processing using native query protocols rather than SQL, ODBC, or JDBC (as is typical of off-the-shelf database platforms).

Decision Engine Application Development System and Process

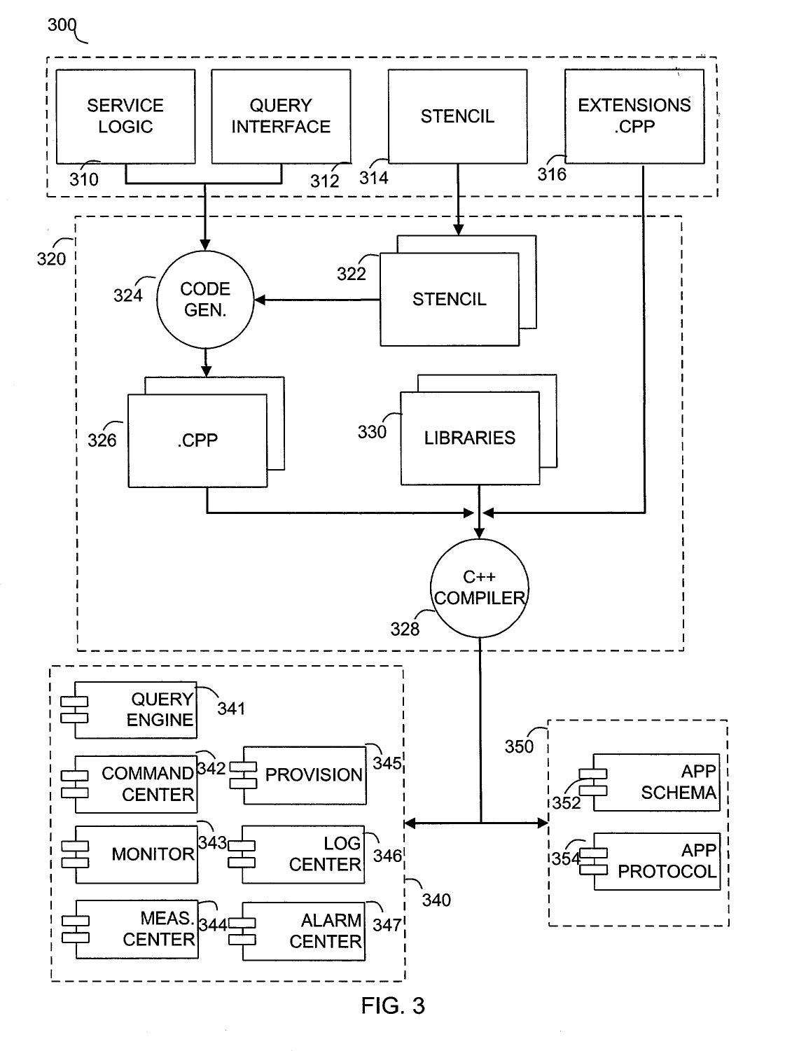

Plug-in components (transports, protocols, schemas, commands, logs, alarms, measurements, etc.) can be maintained and extended by using a software development kit (SDK). FIG. 3 shows a schematic diagram of the system and process used in an embodiment of the present invention used to develop a decision engine for an application to solve a given problem. User inputs 300 define the application's requirements and are fed into SDK 320 to create the application. User inputs 300 may be composed using, e.g., an XML template or other descriptive metadata writing tool. The user could use a graphical user interface (GUI) tool to model the database relationships just as would be done for a conventional database application.

The application development process begins when a user defines the various user input files 300. For example, a user may define service logic 310, which is used to generate schema plug-ins (i.e., table definitions) and other application specific plug-ins used to carry out the required queries. Similarly, the user defines or selects query interface files 312 to generate protocol plug-ins. Finally, the user defines stencils 314 (which may be combined with embedded stencils 322) to incorporate pre-defined and custom data types into the decision engine. Unlike conventional databases, in a decision engine according to the present invention, a user can define his own data types (in, e.g., C++) for use in the tables. This allows users to leverage their existing technologies.

In a specific embodiment of the present invention, service logic 310 and stencils 314 are XML files that describe the service logic and data types and may comprise information such as, e.g., table field definitions (both key and data fields); field-level data-validation rules; provisioning validation rules for add, update, and delete operations; traversal logic; actions to be performed during traversal (e.g., query triggers); and provisioning-command specifications.

Similarly, in a specific embodiment, query interface files 312 are XML files describing the protocols (i.e., query interface) used by the application. Query interface files 312 may comprise information such as, e.g., query protocol message identification; message format; in-coming message field mapping rules; and out-going message field assembly rules.

The metadata files, i.e., service logic 310, query interface 312 and stencils 314 and 322 are all provided to code generator 324 as shown in FIG. 3. Code generator 324 may be a C++ code generator, as depicted in FIG. 3, or may be some other generator such as, e.g., a Fortran generator, C generator, and the like. Output 326 from code generator 324 comprises computer language code used to create the plug-ins for a decision engine for the particular application. Output 326 may comprise one or more C++ programs, as shown in FIG. 3, or some other computer language programs.

Service logic 310 and stencils 314 comprise input files used by code generator 324 to generate classes that manage the data traversal process, collect and/or modify data during the traversal process, and provisioning of table entries. All of this code is compiled into schema plug-in 352. Schema plug-in 352 also includes interfaces to provisioning plug-ins 345 that can accept provisioning commands (add, update, delete, and fetch) for manipulating the contents of the persistent data structures. Similarly, query interface files 312 are used by code generator 324 to generate source code for protocol plug-ins used in the decision engine. The resulting protocol plug-ins 354 parse incoming protocol messages into a temporary data-structure known as the context, as described in more detail in a later section.

In one embodiment, code generator 324 accepts XML descriptions of the various plug-ins; from these, it generates output 326 comprising appropriate source code for the application. Output 326 may be compiled by code compiler 328, which may be a C++ compiler, as shown in FIG. 3, or may be some other code compiler. Libraries 330 may also be linked with output 326 by code compiler 328. Libraries 28 330 may comprise, e.g., pre-packaged libraries such as libpathways and libstencils which may be included in a decision engine product according to the present invention. Pre-packaged libraries 320 comprise one or more system objects such as the context, request, indirection and portal tables which are described in greater detail in later a section.

Finally, the user may include other application extensions 316 which can be compiled by code compiler 328. Application extensions 316 may comprise, e.g., additional application specific requirements which may not be easily defined by metadata. This feature, in combination with the other development processes described above, allows users build a decision engine using expensive programming resources for only a small portion of the overall development process. The remaining application development requirements can be accomplished using the simpler metadata constructs to define the application's logic and structure.

After compilation and linking with the appropriate libraries, the result is the executable program for the decision engine application. As shown in FIG. 3, output from code generator 328 comprises kernel objects 340 and application-specific plug-in objects 350. Kernel objects 340 and application-specific plug-in object 350, together comprise a decision engine application for a particular problem. In this example, kernel objects 340 comprise query engine 341, command center 342, monitor 343, measurement center 344, provisioning plug-in 345, log center 346 and alarm center 347. Application-specific plug-in objects 350 comprise application schema 352 and application protocol 354.

Query Execution in an Embodiment of the Present Invention

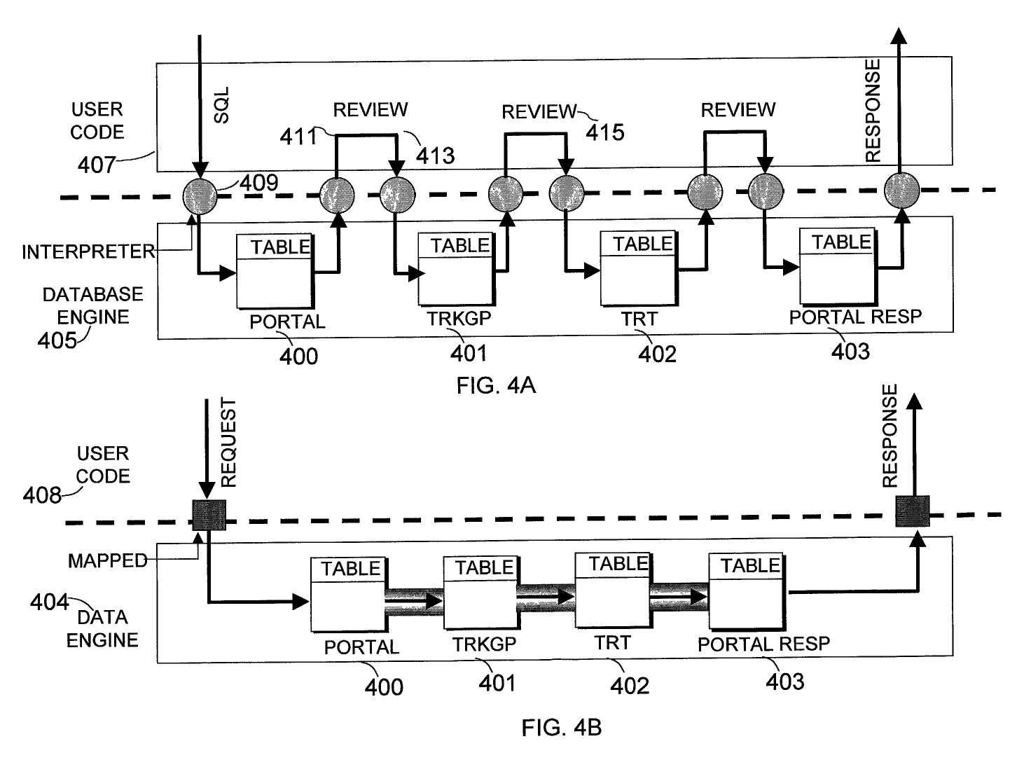

FIGS. 4A and 4B illustrate a primary difference between how conventional databases process a sequential query (FIG. 4A) and how a decision engine according to the present invention processes a deterministic query. Suppose an application requires data stored in various database tables. For example a query may require data from portal table 400, trunk group table 401, trunk route table 402 and portal response table 403. With conventional database engine 405 (FIG. 4A), user code 407 is required to process data received in a sequential series of dips into the database. That is, as shown in FIG. 4A, an SQL query may be sent to database engine 405 and run through interpreter 409. This request is analyzed and processed by database engine 405 and a set of preliminary results is returned in step 411 (after being run through interpreter 409). User code 407 reviews the preliminary results and passes additional instructions to database engine 405 in step 413. Based on the additional instructions database engine 405 returns another set of preliminary results in step 415 for review. The process of user code 407 reviewing preliminary results and issuing subsequent instructions is continued until a final response has been determined, as shown in FIG. 4A.

Each step along the way requires both additional time and additional user code to formulate a response to the query. In contrast, when decision engine 404 of the present invention receives a request from user code 408, all of the processing can be carried out within the decision engine (FIG. 4B). Moreover, because tables 400-304 are hard-coded within decision engine 404, no additional processing is actually required. That is, for a given request, the result is found merely by looking to the correct partition in the portal table 400 which, in turn, is linked to a partition in trunk group table 401 and so forth. When there are no more links to tables (e.g., portal response table 403 does not need to link to other tables) a response is provided to the user.

Accordingly, the present invention eliminates the need for complex coding instructions from the user application and eliminates the need for multiple processing steps. Moreover, because the initial request from user code 408 is processed in a native format, there is no need for interpretation. All of these factor serve to significantly increase performance of the decision engine shown in FIG. 4B over that of the conventional database system shown in FIG. 4A.

Decision Engine Input/Output Subsystem

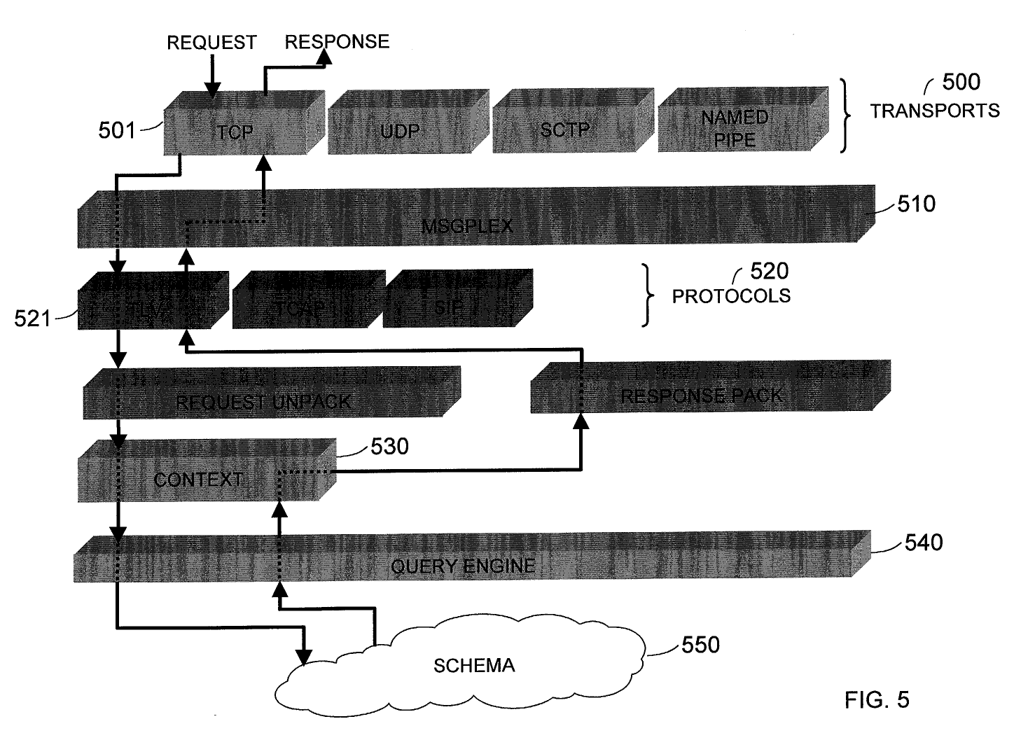

As described earlier, the system and method of the present invention provide complete protocol independence for the user. That is, a decision engine can be easily configured with an appropriate plug-in to handle different transport protocols as well as different application protocols. FIG. 5 provides a high-level schematic diagram showing how the input/output (I/O) subsystem works to accomplish this protocol independence. As shown in FIG. 5, the I/O subsystem comprises transports 500, messageplex 510, protocols 520, context 530 and query engine 540.

Looking first at the downward message flow shown in FIG. 5, when a request message is received from an application via one of the transports, such as for example, via TCP transport 501, the message can be stored in messageplex 510. Messages can be received in a raw transport format. That is, messages are received by the decision engine just as if it were a native system operating in the application's environment. Messageplex 510 can read and write messages using which ever transport protocol is being used by the user. Messages stored in messageplex 510 can be scheduled according to a threading model implemented within the decision engine, as described in a later section. Messageplex 510 works with an appropriate protocol plug-in 520 to prepare messages for further processing. For example, in FIG. 5, the protocol being used is the TLV protocol. After the query message is prepared it is scheduled for further processing. In the next step, the message it is provided to protocol plug-in, e.g., TLV protocol plug-in 521.

When a protocol plug-in, such as TLV plug-in 521, receives a message (from the scheduler) it interprets the query according to the protocol's syntax. This process effectively unpacks the query for placement into context 530. Context 530 is one of the system objects generated by a code compiler when the decision engine is created. The context, is described in more detail in a later section. Query engine 540 processes the query by traversing tables in schema 550.

On the return trip, shown as the upward message flow in FIG. 5, the response packets travel in essentially a reverse path. That is, for example, if the request was sent using a TCP transport it will be returned using a TCP transport. Of course, the user could define his plug-in transports and/or protocols to send and receive messages using different transports, but the current example uses the same transports and protocols for the round-trip (request-response) communication.

Query engine 540 gathers the response from tables in schema 550 and populates appropriate data slots in context 530. TLV protocol 521 retrieves the information from context 530 and packs the response into a format according to the protocol's syntax. The packed response is provided to messageplex 510 for further processing before it is shipped out to the user via TCP transport plug-in 501.

Again, as described earlier, any transports and protocols can be support by the decision engine. There are two ways to accomplish this interoperability. First, the user can write a plug-in defining the transport or protocol used by his application. Such a plug-in could be developed according to the decision engine development system and process described above. Alternatively, the user could provide a definition of the byte streams passed or expected by its applications to some third party application developer, such as e.g., the decision engine developer, for inclusion in the standard pre-packaged transports and protocols provided with the system. The third-party application developer could then use this information to write a plug-in using any appropriate coding tools.

Decision Engine Scalability

As noted above, the present invention is highly scalable. Scalability is required because the decision engine of the present invention is designed for use in many different situations. For example, in some cases, the decision engine may be updated constantly (live updates) and in other cases not at all (static). In some configurations the decision engine may be used to service a low number of requests and in others there will be a very high volume of requests. The decision engine of the present invention achieves scalability by allowing different threading model plug-ins, by providing selectable locking schemes, and by supporting various tunable parameters. Moreover, as described earlier, the decision engine of the present invention is highly portable and can run in a number of different host of configurations ranging from extremely high speed operations to extremely high volume/constant time operations.

1. Plug-In Query Engine Threading Models

The decision engine is completely thread safe and can support any threading model via a generated query engine plug-in as described above. In one embodiment, plug-ins for four different query engines having different threading models are provided as pre-packaged plug-ins. In this section, the function and operation of these pre-packaged query engine plug-ins is described. It would be apparent to one skilled in the art how to develop other query engines and other threading models tailored for particular operating environments. The four pre-packaged plug-ins are referred to herein as: Hot, Pipeline, WorkQueue, and Affinity. Table 1, below, outlines the benefits of each model.

TABLE 1

| Model | Proximity | Performance | Volume | Updates | Processors |
|---|---|---|---|---|---|
| Hot | Embedded | Fastest | High | NA* | NA* |
| Pipeline | Local/Remote | Very Fast | Medium | Low . . . High | 1 |
| WorkQueue | Local/Remote | Fast | High | Low . . . High | 1 . . . Many |
| Affinity | Local/Remote | Fast | High | Low . . . High | 1 . . . Many |

*In an embedded configuration it is up to the application to activate updates

As seen in Table 1, the model to be implemented in a decision engine depends on how the engine is going to be used. Each threading model has distinct benefits as well as disadvantages, which is the reason so many different models are supported.

The Hot model is an embedded solution in which the application links directly with the decision engine library and makes subroutine calls into the engine. In this configuration application calls (via subroutine) must handle all provisioning and updates to the decision engine.

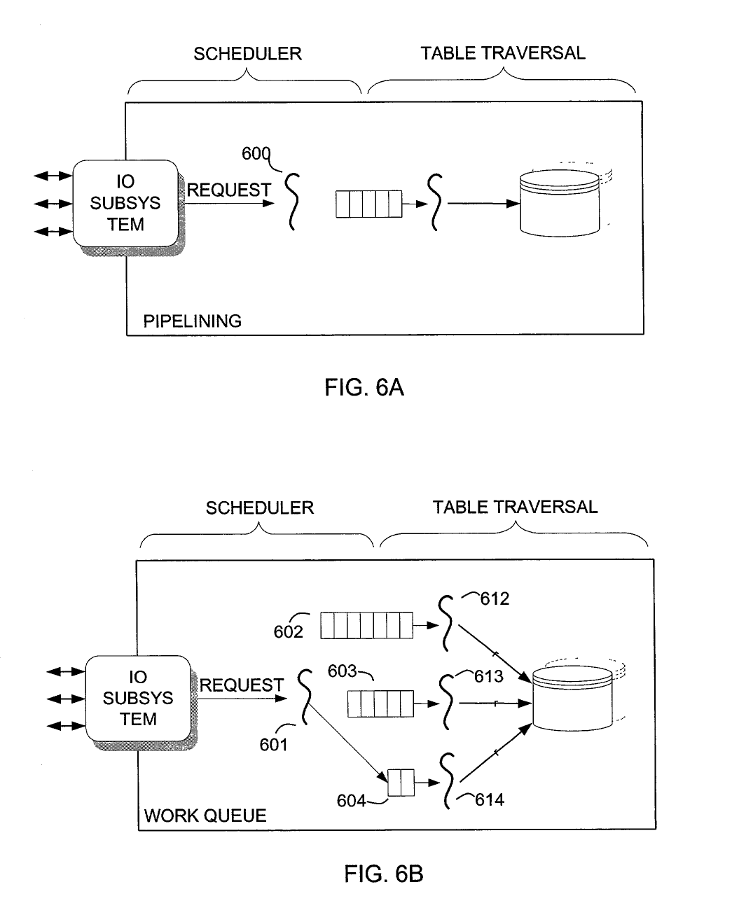

The Pipeline threading model, shown in FIG. 6A, is tailored for servicing a medium number of requests on a single CPU where the response time is still an issue. This model uses a single thread 600 to process the next incoming request, preferably, the thread will maximize the CPU. If processing is interrupted, as could happen, e.g., if an external interaction is required from some other system, the request is handed off to the next thread in the pipeline for continual processing.

The WorkQueue threading model, shown in FIG. 6B, is tailored for servicing a high number of requests where a constant fast response time is required. This model uses a single scheduler thread 601 that places the next incoming request on the least loaded WorkQueue 602-604. Each WorkQueue 602-604 has an associated thread 612-614 that is constantly working (if work is available) by pulling the next request off the queue and processing it. In the case where an external interaction is required the WorkQueue thread dedicates itself to processing that request and starts a new thread for handling the queue.

The Affinity model is similar to the WorkQueue model, with the added capability of allowing a queue to be dedicated to a specific client.

2. Selectable Locking Model

In multi-threaded applications all shared data must be protected from concurrent access. On a typical 100 MHz UltraSparc workstation protecting data via a lock requires approximately 0.03 ms, and each lock adds up. For example, if two threads access the data at the same time, one reading and the other writing, it is possible for the reader thread to get a partial value that has not been completely written by the writer thread. As with the threading model the optimal locking strategy depends on how the decision engine is being used. In installations where high-speed live updates are employed, a row level locking strategy is best. In installations where the number of updates is infrequent, a bucket locking strategy (similar to page locking) is more suitable. Finally, in the case where updates rarely happen, a Read/Write locking strategy is best (concurrent readers, but only one writer).

The following table summarizes the locking model.

TABLE 2

| Strategy | Volume | Performance | Updates |
|---|---|---|---|
| Row | High | Fast | Frequent |
| Bucket | Low . . . High | Very Fast | Infrequent |
| Read/Write | Low . . . High | Fastest | Rare |

3. Tunable

The decision engine of the present invention obtains much of its flexibility and performance by leveraging plug-in technology. The result is a highly customizable (tunable) engine that can perform in a host of configurations. In order to optimize each configuration the decision engine preferably includes capability for real world tuning. In addition to the plug-in options, the decision engine supports runtime tunable parameters. With the assistance of external GUI analysis tools the decision engine can be reconfigured dynamically, while running, to test optimal configurations.

In addition to human tuning, the decision engine can perform its own runtime optimizations: throttling and scheduling.

Throttling.

If, for example, the decision engine is configured with the Live Update Provisioning it can automatically throttle the provisioning system during peak operations. Further, the decision engine can throttle all non-essential plug-ins to increase the performance of routing.

Scheduling.

The decision engine's pre-packaged threading plug-in, WorkQueue also supports priority scheduling. This means that requests from particular applications can be set to always have priority over those from other applications that may use the decision engine schemas, such as, e.g., analysis/external tools applications.

4. Proximity

The decision engine of the present invention supports distributed processing in three ways. First, the decision engine can be embedded into a the physical system already used to serve a particular application that may be utilizing the decision engine. For example, in an AIN environment, the decision engine can be run on the call processor (CP) system. Next, the decision engine can be external to the application server (e.g., the call processor in the AIN example noted above) but on the same local area network as the server. Finally, the decision engine can be eternal and remote to the server. Each of these configurations has advantages and disadvantages, as seen in Table 3, below.

TABLE 3

| Proximity | Advantages | Disadvantages |
|---|---|---|
| Embedded | Speed. | Has to be controlled |
| | No fault tolerance issues. | programmatically. |
| | | Provisioning is not automatic. |
| | | No support for external |
| | | analysis tools. |
| | | No support for tuning. |
| Local | Speed. | Not as fast as the Embedded |
| | Accessible by multiple clients. | solution. |
| | Supports multiple protocols. | High volume steals CPU time |
| | Can be tuned. | from CP. |
| | Part of the fault tolerant | |
| | solution. | |
| Remote | Can be offloaded. | Not as fast as a local solution |
| | Scales to handle high volume. | (network). |
| | Accessible as AIN peripheral. | Separate fault tolerant |
| | Accessible by multiple clients. | solution. |
| | Supports multiple protocols. | |
| | Can be tuned. | |

Invocation Model and Table Traversal

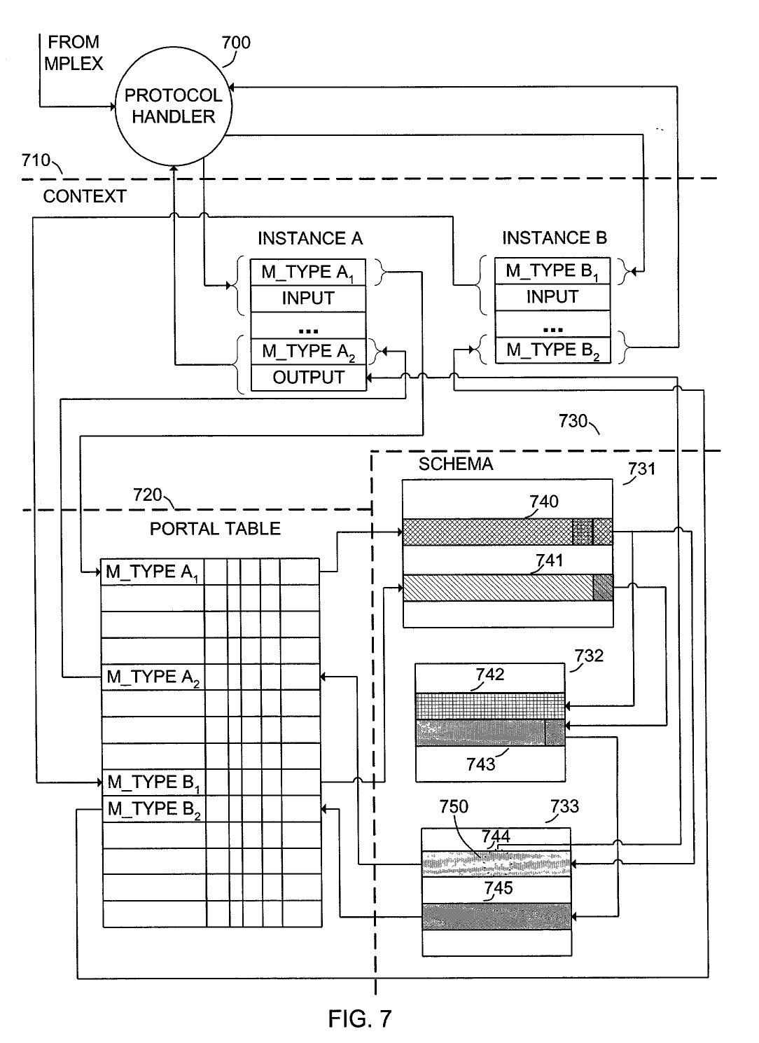

FIG. 7 is a schematic diagram showing an invocation model used in an embodiment of the present invention. The invocation model starts after a query has been passed through the messageplex (MPLEX), and has been unpacked by protocol handler 700. That is, a query message has been submitted over a specific transport mechanism (e.g., socket or FIFO) that is processed by a transport plug-in. The message received over the transport is dispatched to the appropriate protocol plug-in (e.g., SIP, TLV, TCAP, etc.) based on a protocol identifier in the message. Protocol handler 700 (i.e., the protocol plug-in) unpacks the message contents into a temporary data structure, referred to herein as context 710, and enqueues the message into an input queue. Context 710 provides a mapping of input and output data passed from and returned to protocol handler 700 for a given query. Context 710 defines the input data or criteria used in a query and defines the output data expected by the protocol handler. Data inserted into context 710 can be passed along throughout the associated query execution. In essence, context 710 serves as a parameter table that can be read or written to at any stage of the query processing. As database (schema) tables are opened, and as query triggers are encountered, the activity can refer to the context to determine the parameters at issue. Likewise as tables are being traversed, data can be written back into the context to fill-in output data as it is determined.

When the query engine (not shown in FIG. 7) executes the query (i.e., when the query message is at the front of its queue), it refers to context 710 to determine the message type. The message type identifies which row in portal table 720 is relevant to the query. As will be apparent in later sections and examples, portal table 720 comprises a separate row for each message type that comprises the query interface protocol. Moreover, portal table 720, provides an entry to schema 730 comprising the application tables. As shown in FIG. 7, rows of portal table 720 are linked to one or more of the database tables 730 and query execution immediately commences upon access to portal table 720. As described earlier, tables are “hard-wired” to establish pre-formed joins. As shown schematically in FIG. 7, parts of the columns of a table that would be joined to the columns of another table in a conventional join operation are already physically pre-wired. In essence, a query is executed by locating a relevant row in a table and then once that row is identified, it leads directly to the next table and without having to execute another query. If the next table and row are also linked to another table and row, the query execution continues until the last table and row have been identified. As noted above, the context can be updated at any stage of the query processing, and after the query execution is completed, i.e., there is no other linked table or row, the query engine is directed back to a row in portal table 720 to determine the appropriate query response message.

Once the query engine is directed back to portal table 720, it updates context 710 with the appropriate message type (i.e., the response message type). Protocol handler 700 then retrieves the data from context 710 and formats the result data back into the native language of the requestor. As described earlier, protocol handler 700 ships the formatted data back to the transport plug-in (via the messageplex) where it is provided to the requestor via the appropriate transport protocol.

Portal table 720 may comprise separate tables, such as, e.g., a portal request table and a portal response table. Alternatively, as shown in FIG. 7, portal table 720 may be a single adapted to receive request data and to store response data.

FIG. 7 shows two different query operations being processed by a decision engine. Each query operation has its own instance of a context, e.g., Instance A or Instance B. As shown in FIG. 7, input data from each instance is used to identify the appropriate row in portal table 720, which as described above is dependent upon the message type. If the message type for each query were identical, then the same row of portal table 720 would be used to process the queries. Table traversal works as described below.

Consider the query associated with Instance A in FIG. 7. The message type, M_TYPE A₁ indicated in Instance A corresponds to the row identified as “M_TYPE A₁” in portal table 720. This row is hard-wired to row 740 in table 731. Row 740 is further hard-wired to both row 742 in table 732 and to row 744 in table 733. Row 742 and row 744 are linked back the row corresponding to message type M_TYPE A₂, in portal table 720. During the table traversal process, data 750 is written into Instance A as shown in FIG. 7. Once the query is completed (i.e., the query engine is directed back to portal table 720), the data from Instance A is processed by protocol handler 700 and sent on to fulfill the user's query.

As noted above, Instance B is another instance of context 710 and is associated with a different query than is Instance A. In this example, the message type in Instance B corresponds to M_TYPE B₁ in portal table 720. This row is linked to row 741 in table 731. Row 741 is, in turn, linked to row 743 in table 732. Finally, row 743 is linked to row 745, which is not itself linked to portal table 720. When the query engine processing this request returns to portal table 720, the query has been completed. As described above, the data from Instance B is retrieved by protocol handler 700 for further processing before being provided to the requester.

Hard-Wired Links in an Embodiment of the Present Invention

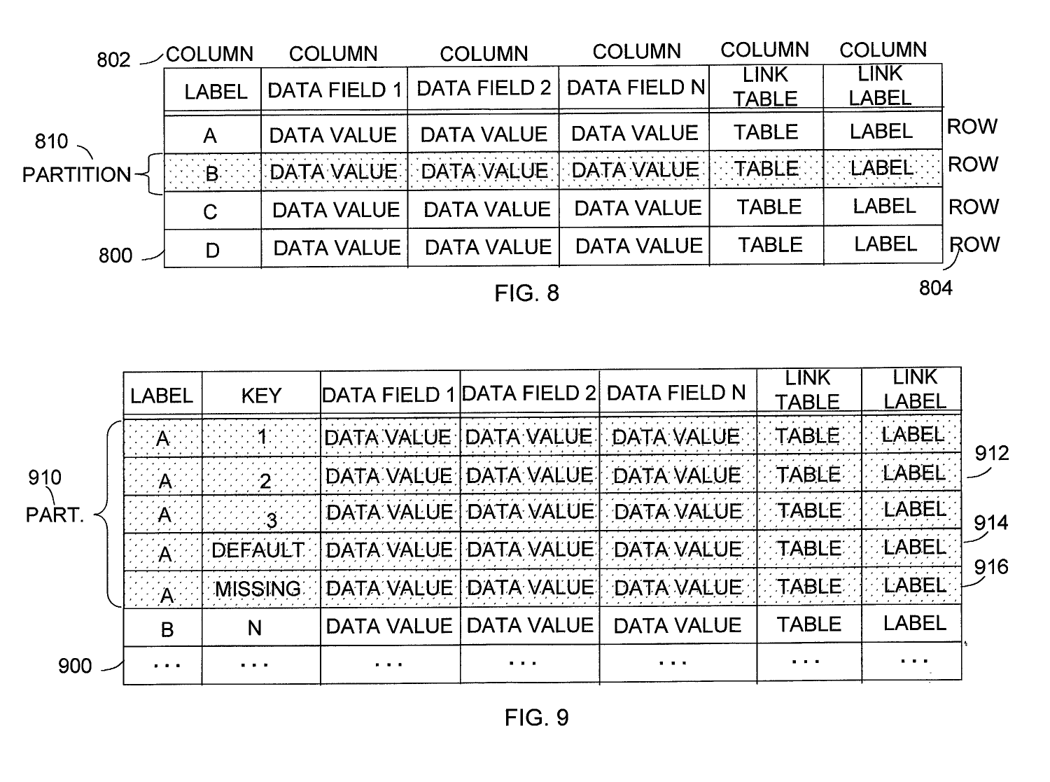

FIGS. 8-11, show in more detail, precisely what is meant by “hard-wiring” schema tables according to the present invention. First, FIGS. 8 and 9 illustrate the attributes afforded to every table in a schema. Tables comprise columns and rows, such as column 802 and row 804 of table 800 shown in FIG. 8. The columns comprise various fields of data. As shown in FIGS. 8 and 9, every table has at least a “Label” field, one or more “Data” fields, and a “Link” field. Label fields define a “Partition” of data within a table. Link fields comprise a “Link Table” field and a “Link Label” field. The combination of link table and link label defines the “Partition Links,” i.e., the next table and partition the query execution process will traverse. More particularly, the link fields are the mechanism used in a preferred embodiment, to achieve a hard-wired relationship between tables thereby allowing rapid processing for deterministic queries. Finally, data fields comprise the actual data of the database.

In addition to the minimally required fields identified above, a table, such as table 900 in FIG. 9, may also include a “Key” field. Accordingly, tables can be either “Keyless” or “Keyed” tables. The difference between keyed and keyless tables is apparent in tables 800 and 900 in FIGS. 8 and 9, respectively. In keyless table 800 partition 810 comprises a single row, having the label “B”. That is, rows within keyless table 800 must have unique label identifiers. In contrast, partition 910 in keyed table 900 comprises multiple rows, each having the label “A.” A particular row, such as row 912 in a partition of a keyed table is uniquely identified by the combination of label and key. For example, row 912 can be uniquely referenced using Label “A” coupled with Key “2.”

In addition to the key values, which are data/application-specific, a partition also comprises “default row” 914 and a “missing row” 916, as shown in partition 910. When a keyed table is being traversed, if a key value is provided in the query (i.e., in the context) but the key value does not match any of the possible key values in the partition, the default row of the partition is used to answer the query. On the other hand, if the query (i.e., context) provides no information regarding the key, e.g., the data field of the query is blank, the “missing row” of the partition is used.

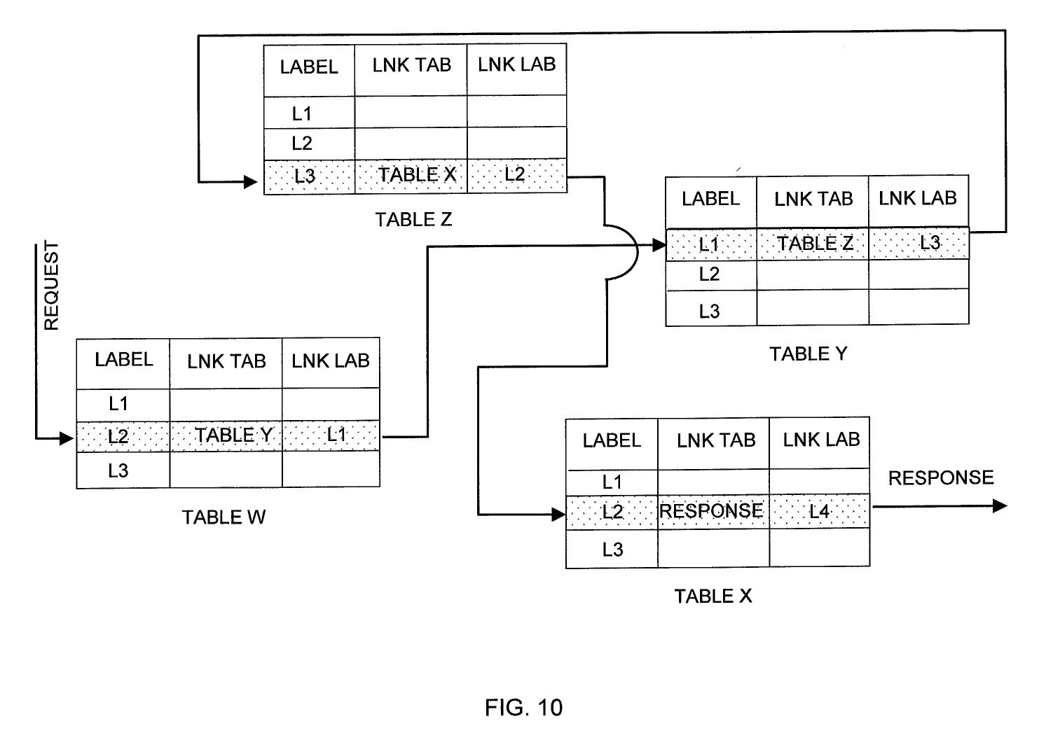

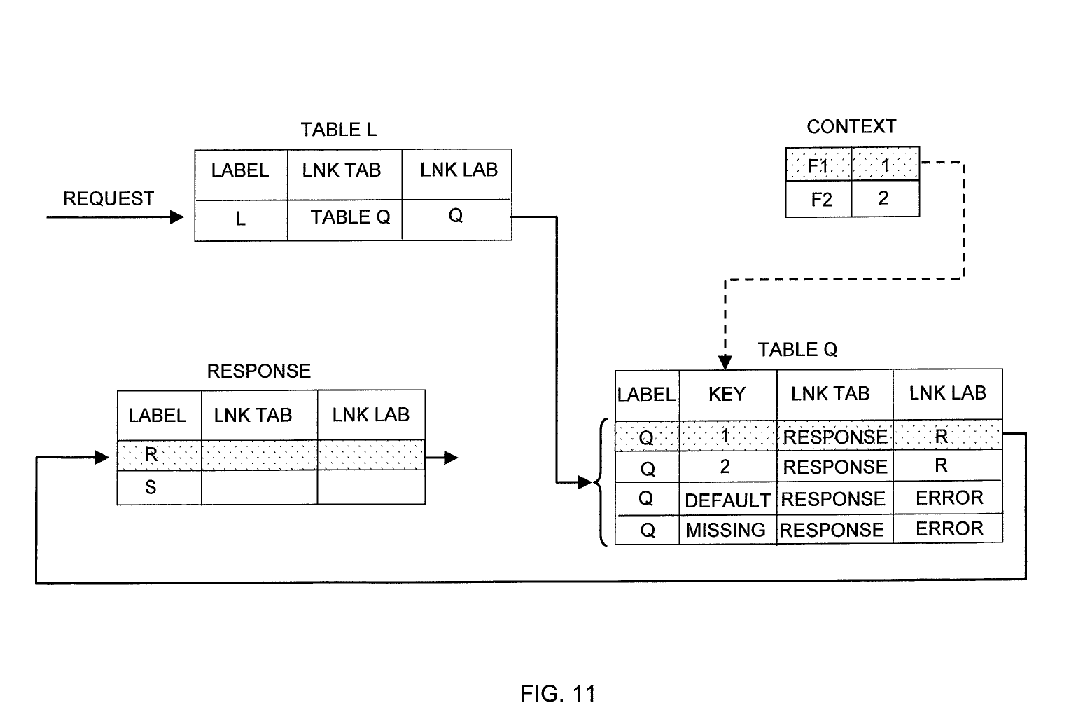

FIGS. 10 and 11 show how tables are linked and how table traversal is accomplished for keyless and keyed tables respectively. As noted above, the link table and link label direct how table traversal will progress to answer a query. These two references are “hard-coded” during the code compilation. That is, rather being merely “pointers” to a table which must then be located and searched for the appropriate row of data, the references comprise a memory location assigned during loading of the decision engine. In this manner, link table and link labels pin-point the next table and partition exactly. There is no need for further examination of any table indexes or for gathering data to be subsequently joined as done in conventional database system. Instead, as described above, once the first table and partition is identified, every other table and partition is automatically apparent.

In FIG. 10, when an incoming query (request) references the partition labeled L2 in Table W, the link label points to Table Y and the link label points to partition L1. Accordingly, the next query processing traverse through Table W onto to Table Y as indicated in FIG. 10. At Table Y, the partition identified by label L1 is further linked to Table Z and partition L3. Finally, Table Z, partition L3 is linked to Table X, partition L2. The link table for partition L2 in Table X points to “Response” table, which may be, e.g., a portal response table, and link label L4. As shown in FIG. 10, the response to the request is formulated according to the information from all four tables W, Y, Z and X.

FIG. 11 shows how table traversal is accomplished when the tables are “keyed” tables. Here, the request comes in and reaches Table L, partition L. This partition is linked to Table Q, partition Q, as shown in FIG. 11. Because Table Q is a keyed table, partition Q may comprise multiple rows. The rows are uniquely identified by the label (Q in this example) and the key value. By referring to the Context, the appropriate row of partition Q is identified. For example, the “key” in Table Q is based on the value of F1 in the Context, as indicated in FIG. 10. That is, e.g., because F1 in the Context equals “1”, the shaded row in Table Q is the appropriate row for responding to this query. As shown in FIG. 10, this row is linked to partition R of the “Response” table.

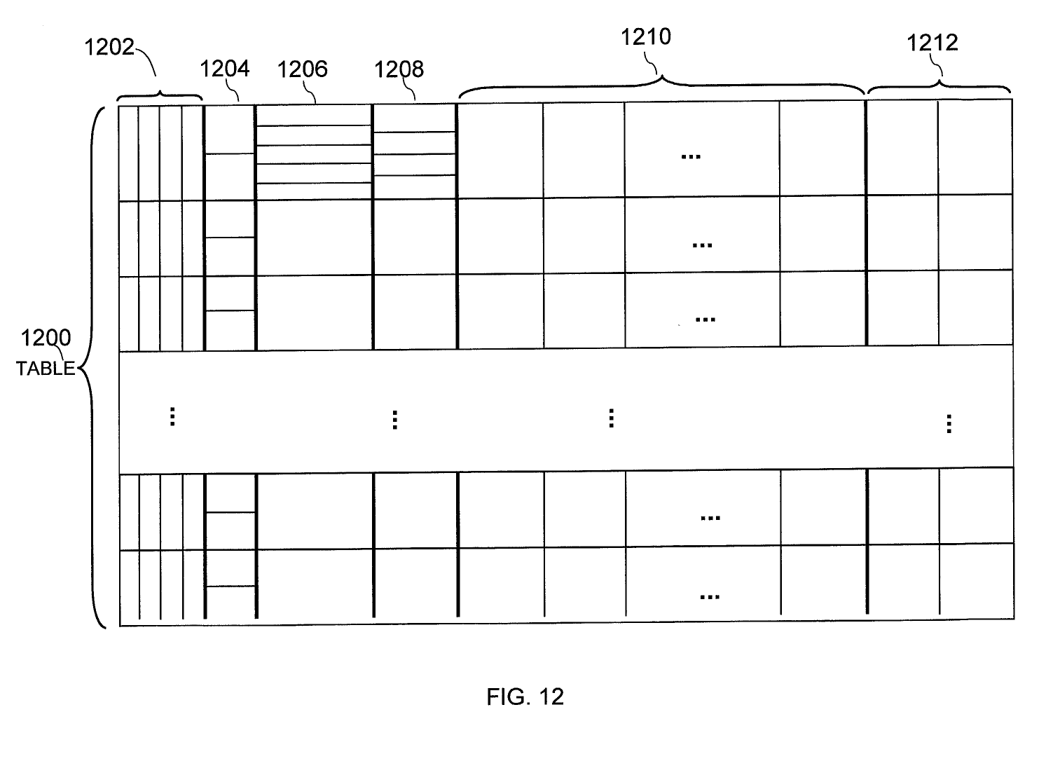

FIG. 12 shows a more detailed view of an individual row that may be found in a schema table according to the present invention. This Figure illustrates more features that may be incorporated into an embodiment of the present invention. The fields available in Table 1220 include key fields 1202, read/write lock field 1204, validation field 1206, actions field 1208, data fields 1210, and link fields 1212. As shown in FIG. 12, a table may include more than one key field. In this case, each row comprises a unique combination of keys, although an individual key may be repeated. Although Table 1200 does not explicitly show the “Label” field, it would be apparent to those skilled in the art, that one of key fields 1202 is a Label field as described above. Read/write lock field 1204 provides a mechanism to implement the preferred database locking scheme for the decision engine's particular application as described above.

Validation field 1206 and action fields 1208 are novel fields that can be advantageously used in a decision engine according to the present invention. Actions include, e.g., opens, queries, triggers, data manipulation and the like. In essence, validators are a type of action. They are used to ensure data entered into the table during provisioning conforms to the data type expected.

Table Traversal in another Embodiment of the Present Invention

Computation and data fetching are performed in Preform by traversing a series of tables. Many of these tables can divided into one or more partitions; a few are restricted to a single partition. Whether a particular table is partitioned (i.e., can have multiple partitions) or not is determined when that table is defined during schema-design and may not be changed at provisioning-time.

Within each partition there are one or more rows. Each row consists of a label field, zero or more key fields, zero or more data fields, and a partition reference called the Successor. All rows within a table have the same layout; they differ only in the values provisioned in the various fields.

Each row of a partitioned table has a label. The label is specified by the Provisioner for every row provisioned into a partitioned tables. Labels do not have to be unique among the rows of a table. In other words, there may be many rows of a given table with the same label value. A partition is defined as the set of all rows in a table that have the same label value. This concept is important in understanding the tables and provisioning of tables.

For tables that are restricted to a single partition, no label value need be specified; wherever needed, it is assumed to be the zero-length label ([ ]).

A Partition Reference is a pointer to a partition. A primary use for partition references is for the Successor field that appears in each row. These successor fields are used to control the chaining between tables and so the order of table traversal.

Partition references are usually denoted using the syntax table[label] where table is the name of the table containing the partition and label is the label value that defines the partition. Table names are defined during schema-design; label values are selected at provisioning time.

Partition references that point to single-partition tables still use the square brackets; In this case the syntax is simplified to table[ ]. NOTE: In provisioning commands and in sample table layouts, partition references are usually split into two portions, the table and the label, that are listed separately. The table[label] notation is used when referring to the partition reference as a whole.

Tables may be defined to be either keyless or keyed. A keyless table has exactly one row per partition. A keyed partition, on the other hand, has one or more rows per partition. These rows are distinguished from each other by one or more fields known as keys.

A partition reference that points to a keyless partition effectively points to the one row in that partition. When traversing tables, no run-time searching is performed upon reaching a keyless table: the one row in the designated partition is used.

Upon encountering a keyed table, however, a search must be performed to select the appropriate row from within the designated partition. The search algorithm may vary from table to table, depending upon the key fields and the search algorithm specified during schema design.

Features inherent in keyless tables include:

Each partition contains a single row; each label value distinctly identifies that row.

There are no “key” columns because there is no need to distinguish between rows of a partition.

In contrast, features inherent in keyed tables include:

Each partition contains one or more rows; each distinct label value identifies the rows of one partition.

The “key” column distinguishes the rows within a partition; each key value distinctly identifies a single row within a partition.

Rows in different partitions may share key values; each distinct combination of label and key values distinctly identifies a single row.

There are multiple possible sources for the key values that are used to search a table during dial-plan traversal, including context fields or computed values such as the time-of-day or the temperature in Kansas City. The most common source for key values is the context. Key values required to resolve a traversal to a single row in a keyed table partition can be retrieved from one or more fields of the context structure.

This process is central to the operation of the dial plan. Consider, for example, a table that is used for Called Number Screening. The label could be used to partition the table into partitions with each partition representing a distinct customer or set of customers. The key field, Called Party Number (with sub-fields NOA, NPI, and Called Digits) allows identification of the single row within a particular customer's partition. This is where indexing and look-up algorithms enter the dial-plan design: the dial-plan designer may make decisions concerning how the data are to be represented in the tables and searched at runtime. The key values for the search process (NOA, NPI, and Called Digits) are retrieved from the appropriate context fields, which were previously copied from a protocol request message. Alternatively, key values can come from other sources such as the system-clock or even a random-number generator.

The key value(s) used to select a row of a table is (are) known as the presented key.

There are two conditions associated with keyed tables that Preform handles in a special manner:

A key value is not available from the expected source. For example, one cannot search a Caller Screening table if the Calling Party Number is not available in a particular call-setup request message.

None of the provisioned rows matches the presented key.

Each of these situations is handled in a similar manner: a unique special row, one for each of these two cases, is defined for each keyed partition. The missing row is used when the search cannot be performed due to the absence of a key value; the default row is used when a search fails to find a matching row in the table. Note that there is one of these rows for each partition, not one per table (unless, of course, the table is a single-partition table).

The missing and default rows do not have any key fields associated with them; otherwise they have the same structure as normal rows, including provisionable data fields and successors. In some cases, provisioning edit-checks for these two rows may also differ from the edit-checks performed on normal rows.

The concepts of missing and default rows are so important in Preform that one is prohibited from using a partition reference that points to a partition with either of these rows unprovisioned. One is also prohibited from provisioning a normal row of such a partition until both of these rows are provisioned. Similarly, one cannot delete either of these special rows until there are no remaining normal rows in the given partition and there are also no outstanding partition references that point to the given partition. A partition that has both special rows present is referred to as an initialized partition. One that is missing one or the other of these rows is uninitialized. The provisioning rules with respect to partition initialization for keyed tables are as follow:

Only missing or default rows may be added to uninitialized partitions; normal rows may only be added to initialized partitions.

A partition becomes initialized when the missing and default rows have been added.

Partition references may not refer to uninitialized partitions.

Missing or default rows may not be deleted from a partition that is referenced by any partition reference.

Missing or default rows may not be deleted from a partition that contains any normal rows.

A partition reverts to the uninitialized state when either the missing or default row is deleted.

The above rules apply only to keyed tables: keyless tables have exactly one (normal) row per partition. Partitions in keyless tables are never uninitialized: the partition does not exist the one row is added and keyless partitions may be considered initialized as soon as that one row is added.

The above description was actually a bit simplified: for some keyed tables the missing row is not used. These are tables where the key value(s) will always be available when the table is reached. For example, the key value might come from a parameter in the request message that is defined as mandatory in the protocol. Alternatively, the key value might be derived from a source that is always available, such as the system clock. In such situations, the missing row does not exist in any partition of the table and the above rules for initialization and provisioning should be restated to refer only to the default row instead of the missing and default rows. Note that there is no analogous situation in which the default row is omitted.

Many possible search algorithms may be implemented for selecting rows in keyed tables including, for example:

Exact-Match: the row selected is one that is provisioned with a key field that exactly matches the presented key.

Range-based: the row selected is one that specifies a range of values where the presented key is within that range.

Sequencing: on first entry to a particular table, the row with the lowest numbered Row Id is selected; on successive entries to the table the row with the next greater Row Id (than the last time) is selected.

Percentage: the presented key is a computed quasi-random number that selects between the provisioned rows of a table according to provisioned percentages. (In this case, a Row Id is typically used as the a key for provisioning purpose but not for row-selection purposes.)

Although successors were mentioned above, their use was not explained. A Preform query message is processed by traversing tables, one table at a time. Processing starts at the Request (REQ) table: this special (predefined) table has exactly one row for each type of incoming request message defined in the query protocol. The successor in each of these rows is a partition reference that points to the first table partition among the application tables: processing continues at that partition. If the indicated partition is keyless, then the designated row will be selected; if it is keyed then the appropriate row will be selected from within the partition using the search algorithm defined for that partition.

Each row so encountered will also have a successor that will select the next table partition to be traversed. This continues until one reaches a row that points to a partition in the Response (RESP) table. When the RESP table is reached, a response message is generated and returned to the source of the original request message.

As each row is traversed, zero or more actions that have been associated with the table (during schema design) may be executed before proceeding to the next table partition. These actions are performed in a predetermined order and are the same for all rows of a table. Note, however, that actions may be complex and may use values stored in the data fields of the row or in the context to affect their behavior.

Among the more common types of actions are the following:

set context: Copy the value of a data field to the context.

modify context: Modify a value in the context, perhaps using one or more data fields in the row to control that modification.

clear context: Remove a value from the context.

implicit successor: Override the explicit successor provisioned for this row with an implicit partition reference defined during schema design.

context indirection: Override the explicit successor provisioned for this row with a partition-reference value previously stored in the context.

subroutine call: Process another table partition with the intention of returning to processing remaining actions in the current row.

Other sorts of actions may also be defined for any particular table, including combinations of the above actions, conditional actions, etc.

In some instances it may be necessary to override the normal processing flow that is established by the successors in each row. For example, if an action detects an error condition that makes it impossible to continue processing a telephone call (in a telephony routing and translations application), it might be appropriate to branch to a partition in a Call Treatment table.

To this end, an action may define implicit successors. The partition references used for such implicit successors are not provisionable; they are defined as part of the action during schema design. An example of such an implicit successor in an action might be something like “If the context field X contains fewer then 3 digits, then go to TRT[Insufficient Digits in X]; otherwise delete the leading 3 digits from X.”

High Availability Configurations for Data Engines

This section provides a detailed description of the high availability provided by one aspect of the present invention. This aspect of the present invention provides a distributed provisioning solution which can be used for routing/dial-plan data, as well as bearer and element provisioning data. Data updates are replicated to decision engines in the cluster, and bearer and element data updates are provided to registered external clients using a distributed publisher/subscriber model described in later sections.

1. Decision Engine Cluster

A decision engine cluster according to present invention comprises of two or more instances of the decision engine executable running on the same or different physical hardware (comprising the cluster). Each decision engine (node) in the cluster is synchronized and as a result provides maximum availability, scalability, and the basis for load balancing. An object-oriented framework and software development kit as described in earlier sections above, enables a repeatable process for the creation and maintenance of routing and provisioning infrastructures using an XML based information model specification.

The decision engine cluster provides high performance and reliability for routing applications, including the following capabilities:

Near real-time routing. Updates cannot effect routing response time.

Availability. All Pathfinders in the cluster must be able to service any requester on demand.

Accuracy. Route requests cannot be interrupted by updates.

Scalability. Additional nodes must be able to be added to the cluster dynamically.

For provisioning applications, the decision engine cluster provides:

Reliability. All nodes in the cluster must remain synchronized.

Availability. Use any node in the cluster for provisioning.

A decision engine cluster provides a resilient architecture for distributed and/or load-balanced routing in addition to reliable distributed provisioning solution for both routing (dial-plan) and non-routing (element provisioning) data alike. In the following sections the distributed routing and provisioning models of a decision engine cluster are described, followed by procedures for updating software and migrating data in a live decision engine cluster.

2. N-Way Active Routing

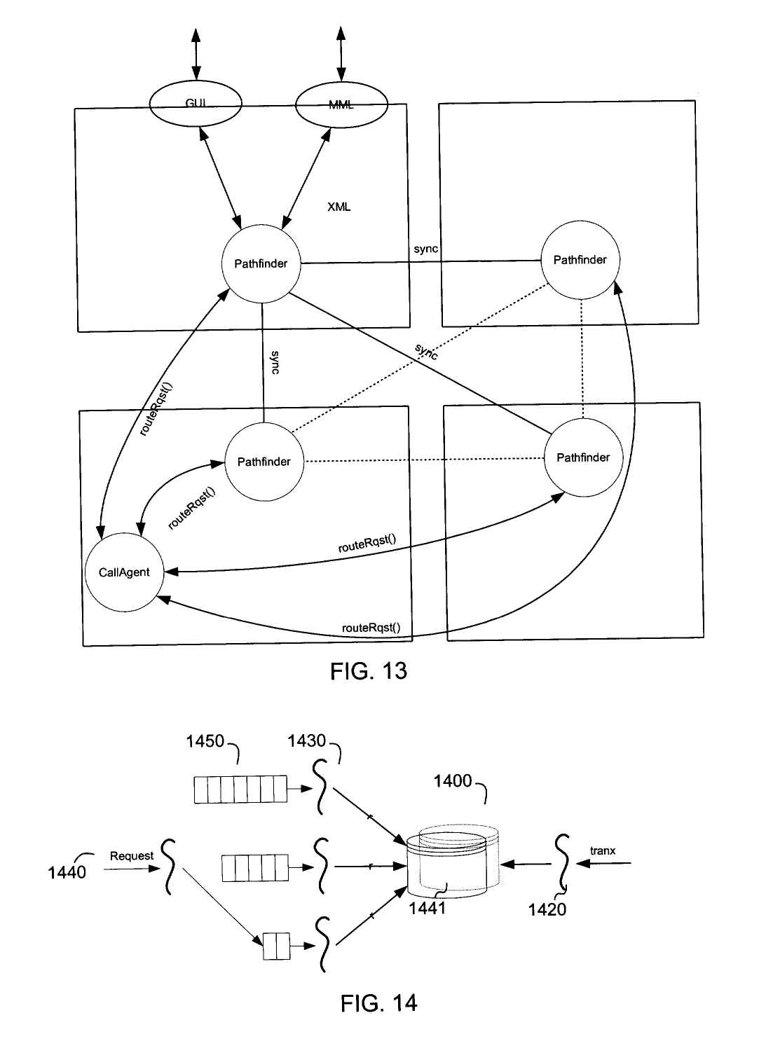

FIG. 13 is a schematic diagram illustrating N-Way Active Routing. In this configuration, all nodes are active with respect to routing. This means that a routing request can be sent to any executing node in the cluster without regard to state and be guaranteed accurate. This is achieved by implementing a synchronization model, that keeps all nodes in the cluster up-to-date and in-service. This is made possible by the stateless nature of the data being managed. When a node comes up it immediately synchronizes with the cluster before going into service. Once in-service, clients are free to send route requests to it or any other node in the network.

N-Way Active Routing greatly simplifies the fail-over programming model for the client and the decision engines by putting the emphasis on connectivity instead of fail-over handling. This means that routing clients only need the ability to connect to any one node in the cluster, regardless of who is active (all are active). For example, if a node in the cluster is taken down for maintenance the client simply has to connect to another node and pick up where it left off.

With N-Way Active Routing it is possible to achieve Telco-grade availability as well as distribute the workload across multiple nodes in the cluster to facilitate horizontal scalability. Since all nodes in the cluster are synchronized they behave as one node, thus enabling any number of nodes to be added to the cluster.

3. Continuous Routing

The performance of N-Way Active Routing is near real time and is not impacted by the synchronization process. This high performance in this embodiment is attained via Continuous Routing; that is servicing routing requests without delay regardless of whether the cluster is up or not. Continuous Routing is achieved by using shadow database 1400 in conjunction with live database 1400 as shown in FIG. 14. Shadow database 1400 is used to apply transactional updates 1420 (some of which may be large or in bulk). When the transaction is committed all current route requests 1430 are allowed to finish and then shadow database 1400 is swapped with live database 1410 in one instruction. After the swap has been completed the previously live database is updated to become the new shadow database.

As seen in FIG. 14, input route requests (1440) are scheduled by a single thread onto the least loaded work queue 1450 to be executed by a worker thread in live database 1410. At the same time transactions (tranx) 1420 are being applied to the shadow database 1400 by another thread. When the transaction has been completed the shadow is made live.

Another benefit of the Continuous Routing model shown in FIG. 14 that it simplifies the internal locking strategy by allowing route requests to run lock-free (once a route request is executing it executes lock-free). Moreover, the case where only a single client is accessing live database 1410, locking can even be reduced to the point where updates are lock-free.

4. Replication

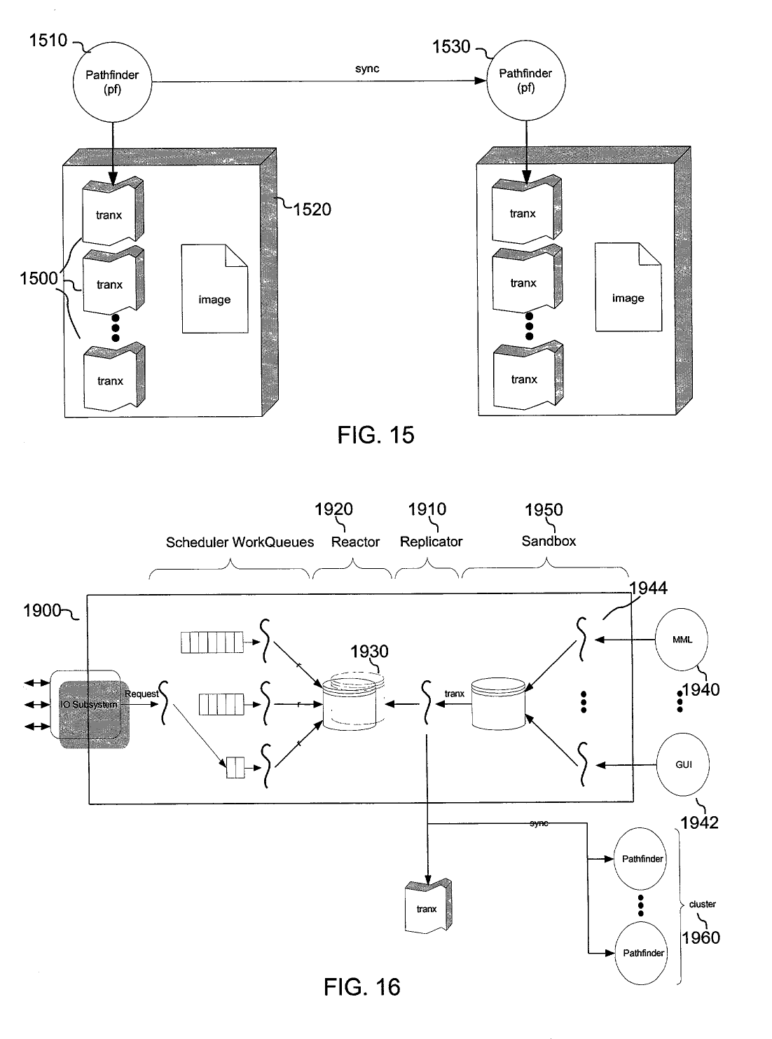

As shown in FIG. 15 the present invention incorporates a replication strategy that is resilient to network failures and tuned specifically for replicating data in an environment where Continuous Routing is required. As transactions are committed e.g., by decision engine 1510, the Rollforward segment of the transaction is first persisted to local disk 1520 and then transmitted to all the active nodes (e.g., decision engine 1530) in the cluster (which also persist the transactions). When the cluster has been synchronized, each Pathfinder applies the updates to the shadow database and swaps the live and shadow databases (as seen in Continuous Routing). As a result of the persistent Rollforward approach, bootstrapping is simplified since the initializing node can request the transactions from any other node in the cluster.

The high availability architecture describe above includes the following features:

Asynchronous replication. When the majority of the nodes in the cluster are up, transactions can be persisted and replicated asynchronously to achieve better performance.

Versioned table support. This ensures consistency within the cluster by requiring that table schemas match for both routing and non-routing tables.

Dynamic cluster configuration. Nodes within the cluster can be added and deleted without bringing the cluster down.

Transparent fail-over. If the node responsible for updates fails another node within the cluster will automatically take over the responsibility for replication.

On-line backup. Live backups can be performed while provisioning is in process by temporarily postponing the shadow database from being swapped to the live database.

On-line restore. Similar to on-line backups, on-line recovery can be performed by pausing provisioning activities while a new shadow database is loaded and then swapped to the live database.

Bulk loading support. Bulk loading uses the same process as On-line restore in that the shadow database is updated with a bulk load before it is swapped to the live database. Note that provisioning can continue during a bulk load.

5. Conflict Avoidance

Unlike conventional database systems which employ conflict resolution strategies, the present invention is designed to avoid conflict and minimize complexity. The reasons a decision engine-cluster can employ conflict avoidance tactics are because of the nature of the data being managed and the fact that Continuous Routing has to be achieved. In this architecture, replication is not given the same performance priority as routing (routing has precedence) but it does have the same priority with respect to reliability and availability. Three conflict avoidance techniques can be used in a decision engine-cluster: a quorum model, replication/reactor architecture, and n-way masqueraded provisioning. Each of these strategies is described in greater detail below.

a. Quorum Model (Majority Rules)

In the quorum model it takes a majority of nodes, floor(nodes/2+1), to form a quorum (the minimum number of members that have to be present before the cluster can transact business). When a quorum has been established provisioning is enabled. By using this model the cluster is guaranteed to be in sync as nodes come up and go down. It is important to note that even if a quorum can not be established Continuous Routing is still available.

b. N-Way Masqueraded Provisioning

Decision engines according to the present invention utilize a Master/Slave configuration to ensure changes only occur on one node and that all propagation flows from the master to the slaves. Each slave, however, is perceived by its clients (MML, GUI's, etc.) as a provisionable node—i.e. the master. When a client connects to a decision engine node to perform provisioning, the node determines who the master is in the cluster and forwards all input from the client to the master and all output from the master back to the client. This process is called master masquerading and allows clients to treat the cluster topology as a single unit.

c. Replicator/Reactor Architecture

The master node 1900 within the cluster contains a Replicator 1910 that is responsible for replicating updates to all the slave nodes within the network and back-filling initializing nodes as shown in FIG. 16. All decision engine nodes (master and slaves) contain a Reactor 1920 that is responsible for receiving updates from the master node Replicator 1960 and applying them to the shadow database 1930. In the case where the master decision engine 1900 is taken out of service a designated takeover slave starts a Replicator process and assumes the master identity. At any one time, only one Replicator can exist within the cluster and every decision engine, such as node 2000 will be running a Reactor process.

FIG. 16 depicts a master decision engine 1910 servicing many provisioning clients including MML client 1940 and GUI client 1942. As these clients commit transactions 1944 in Sandbox 1950, the transactions are handed over to Replicator 1910, which forwards the transactions to Reactor 1920 and replicates them to other nodes 1960 in the cluster.

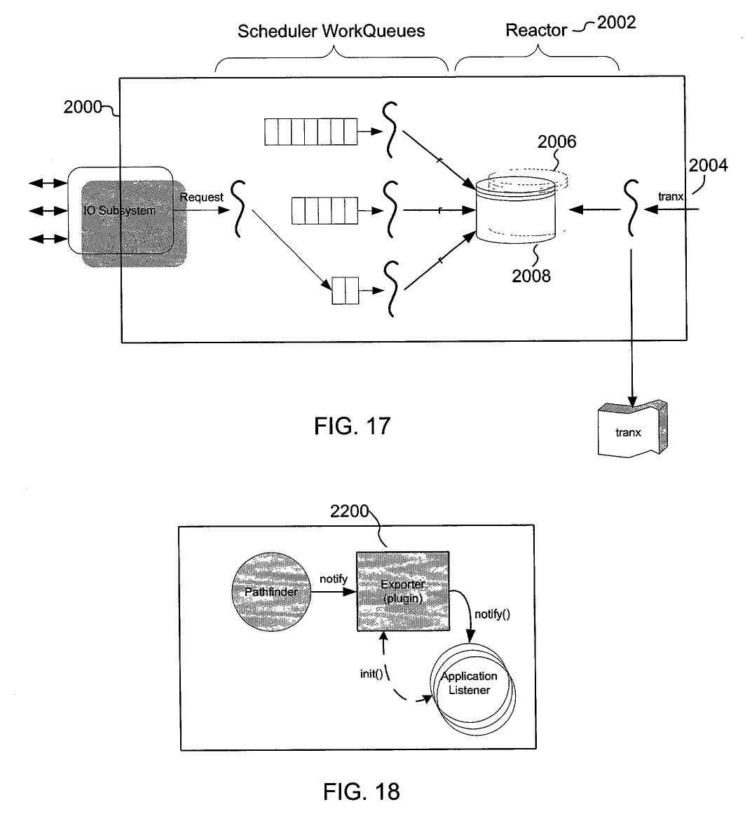

FIG. 17 shows decision engine 2000 running only Reactor 2002 (e.g., decision engine 2000 is a slave node). The Reactor receives transactions 2004 from an external master Replicator such as Replicator 1910 running on node 1900, persists transactions to shadow database 2006, and finally applies the transactions to the in-memory data store, i.e., live database 2008.

6. Transaction Rollup

All transacting systems have some mechanism for rolling up transactions; that is removing them from disk when they have been permanently persisted to the data store. In most databases this rollup occurs as a result of one or all of the following events: execution of a commit, the transaction segment reaching a threshold point in size, or at pre-determine times. Decision engines according to the present invention, only implement the latter so the rollup can be configured to occur during non-peak operating times. The process of rolling up the Rollforward transaction segment is the responsibility of the master (with respect to provisioning) decision engine. The master contacts the slaves in the cluster, synchronizes, and commands each one to rollup their transaction logs.

7. Updates and Patches

Updates and patches can be implemented for a decision engine without impacting the operational capabilities of the cluster. For example, patching a decision engine with a new minor point release, in which the underlying database schema has not changed, is as simple as:

Dynamically remove the out-of-date decision engine from the cluster (will stop all updates).

Start the patched decision engine (will automatically synchronize with the cluster); and.

Stop the out of date decision engine (will drop all clients forcing reconnection).

Major updates to a decision engine or the database schema requires bringing up a new cluster (typically on the same hardware). The data cluster supports the ability to run different versions within the same cluster so updates can be performed transparently. As applications are cut over to the new configuration they simply have to connect to the new cluster.

Table 4 summarizes the impact of updates:

TABLE 4

| Update | Scope | Resolution |
|---|---|---|
| Minor | Node | Install, stop, and restart the node |
| Major | Cluster | Bring up a new cluster in parallel with the |
| | | cluster being updated |
| Schema | Cluster | Bring up a new cluster in parallel with the |
| | | cluster being updated |

8. Data Migration

Data migration is only involved when the database schema is changed. In order to migrate data from one version to the next a new cluster is started (as with major updates). Once the new cluster is running the old data can be exported and imported into the new using a data migration tool. Note: the data migration tool's rules can be generated along with the new database at the SDK level (where the old database is mapped to the new database with the appropriate conversions applied).

9. Change Notification

In order to facilitate data sharing a decision engine-Cluster provides access to its internal database via the Exporter plug-in. The internal data structures are not, however, exposed. Instead, only the exported data fields of each table are available to the outside world (as defined in the XML table definitions). This allows the Exporter to send smaller binary notifications of data updates in a format that requires no translations or conversions. The Exporter can be used primarily as a mechanism to distribute non-routing data to provisionable data clients distributed throughout the decision engine Cluster.

Access to the internal database is provided in two ways: snapshot (for bootstrapping) and change notification (for updates).

a. Snapshot Support

When clients that are dependent on table(s) within the a decision engine are initialized they can request snapshots from the Exporter 2200, as shown in FIG. 18. These snapshots are streamed to the client in their exported native format using a TLAV (Tag<Table> Length Action Value) protocol. The Action portion of the protocol is always INSERT in this case and is included to simplify client side handling (i.e., this enables the snapshot and notification handlers to be one in the same). Provisioning can be temporarily paused during a snapshot to ensure data integrity and that the client will receive the proper updates.

b. Subscription Model

The Exporter plug-in follows a publisher/subscriber pattern in which clients subscribe to a publisher, in this case the Exporter, for change notification. As changes are applied to the decision engine's internal data store they are forwarded to the Exporter, which in turn converts and transmits the data to all registered clients. In order to stay synchronized with the internal database a client can subscribe to the Exporter in one of two ways:

Subscribe with snapshot (request a snapshot followed by incremental updates).

Subscribe without snapshot (request only incremental updates).

c. Exporter Proximity

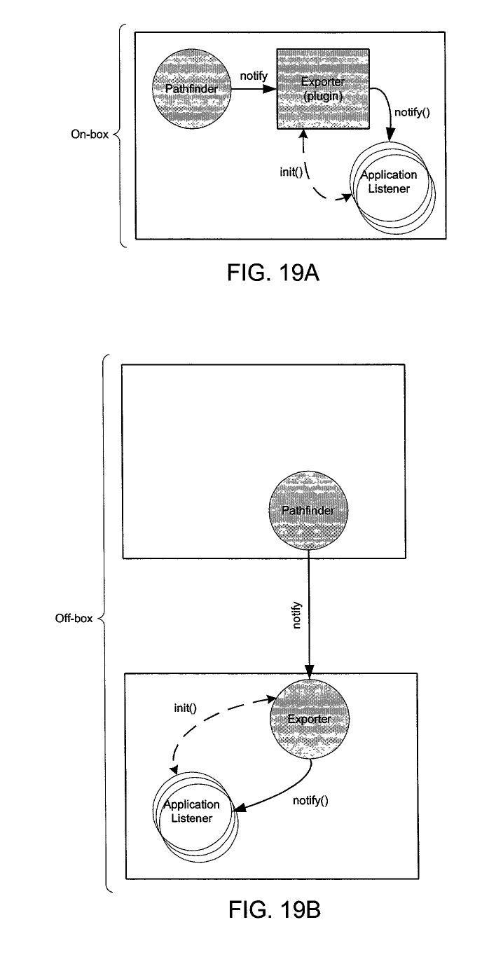

To facilitate scalability the Exporter can be either embedded within a decision engine (i.e., as a plug-in) as shown in FIG. 19A. Alternatively, the Exporter can be distributed to a proxy process as shown in FIG. 19B. This allows clients to use the same transport regardless of where decision engine is running (local or remote) and to transparently interact with the cluster as a single unit. For example, if a decision engine is running local, client(s) can connect and use the Exporter plug-in directly. If at a later time decision engine is off-loaded, an Exporter proxy can replace the local date engine thus enabling the client(s) to remain unchanged. In addition to these off-loading benefits, the proxy also has the benefit of shielding clients from nodes coming up and down within the cluster. That is, if the proxy losses contact with a node it will automatically connect to another node in the cluster; thus relieving the client(s) from this responsibility.

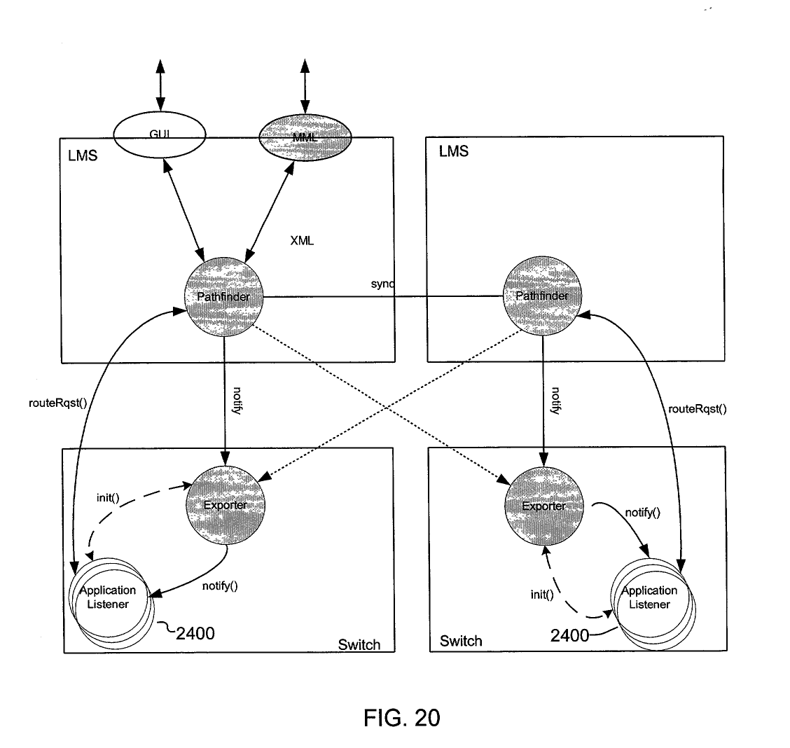

FIG. 20 refers to an overall cluster configuration using proxy Exporters. In this configuration the Application Listeners 2400 would include a CallAgent (i.e. decision engine routing client) as well as supplemental processes that require provisioning data. The decision engine have been offloaded to a Local Management Server (LMS) to improve performance and scalability.

### EXAMPLE 1

### Decision Engine Solution for Billing in a Wireless Service

This example illustrates how the present invention can be implemented in support of a billing service for a wireless telephone service provider. The example shows how tables and programming logic are designed and linked to provide a rapid response to a query.

1. Problem Scenario

The wireless service provider wants to create a special billing process wherein when a subscriber uses his wireless telephone for a location within his “home zone.” For example, the wireless provider may offer free airtime any time the subscriber is within the home zone to be more competitive with wireline services that charge a flat monthly rate to subscribers. But in order to offer this special billing, the wireless provider needs to identify all calls that qualify for the program and mark its billing records accordingly. As described below, the wireless provider can readily determine the location of the wireless telephone at least to the degree necessary to provide this service. However, problem is using this information to determine whether or not that location is the subscriber home zone.

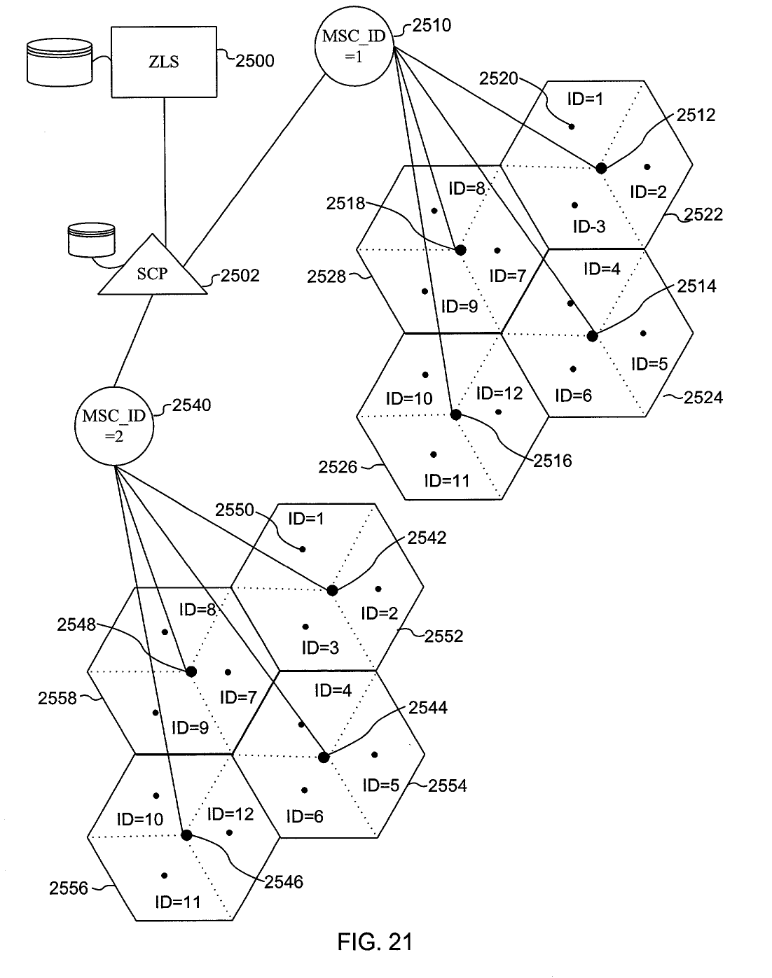

As known in the art, wireless telephone calls are relayed from a radio base station to a mobile switching center (MSC) where the calls are integrated into the public switch telephone network (PSTN), or, if the call is to another wireless telephone, it may be processed by the same MSC or another MSC for transmission to a base station serving the called wireless telephone. FIG. 21 is a schematic diagram showing the basic architecture typically used for providing wireless telephone service. MSC 2510 is linked to base stations 2512, 2514, 2516 and 2518. Base stations 2512, 2514, 2516 and 2520 provide coverage to cell sites 2522, 2524, 2526 and 2528, respectively. As shown in FIG. 21, different MSCs service different geographic regions. So, e.g., MSC 2530 serves base stations 2542, 2544, 2546 and 2548, where are located in cell sites 2552, 2554, 2556 and 2558, respectively.

Base stations typically have three directional antennas which further divide a cell site into what is known as a sector. Each of the directional antennas is assigned a Location_ID which is unique for a given MSC. For example the three antennas of base station 2512 may have Location_IDs 1, 2, and 3 and base station 2542 may also have Location_IDs 1, 2, and 3, because the two base stations are serviced by different MSCs as shown in FIG. 21. Similarly, each MSC is assigned a unique MSC_ID. For example, MSC 2510 may be assigned MSC_ID=1 while MSC 2530 may be assigned MSC_ID=2, as shown in FIG. 21. Accordingly, the combination of MSC_ID and Location_ID can be used to identify the sector in which a subscriber is using his wireless telephone.

As known in the art, every wireless telephone (and all wireless devices in general) is assigned a unique mobile identification number (MIN). Each MIN is associated with a particular subscriber and subscribers may be associated with multiple MINs (i.e., the subscriber may have wireless telephones). Because MINs are unique they can be used to identify the subscriber to whom a wireless telephone belongs. Accordingly, the combination of MSC_ID, Location_ID and MIN can provide enough information to process a query to determine whether or nor a wireless call is placed or taken with the subscriber's home zone.

In this example, a wireless subscriber's “home zone” is defined as the sector in which the subscriber lives. A home zone could also comprise multiple sectors, as illustrated further in this example. Any calls placed from or terminated to the subscriber's wireless telephone while in his home zone will be afforded the special billing as discussed above. The problem at issue is determining whether or not a call to or from a particular section qualifies for the special billing rates.

As described above, an MSC can already determine the base station and sector involved in with a particular call as well as the subscriber's MIN. MSCs are not, however, equipped with databases of subscribers and home zones so the actual billing determination must come from an external source. A service control point (SCP), which generally comprises databases and service logic (i.e., computer applications), could be used to determine whether or not a subscriber is using his wireless telephone from his home zone. However, implementation of a home location service on a n SCP would require new programming logic and new data structures for the SCP. Also, as known in the industry, SCPs are very expensive systems and are critical to telephony call-routing and other subscriber services. As such, implementing any new services on an SCP generally requires many months to ensure proper operations and inter-operability with existing services.

2. System Implementation

In this example, the service logic and data are placed on ZLS server 2500 which is in communication with SCP 2502, as shown in FIG. 21. When a wireless call is being set up, a trigger on MSC 2510 or MSC 2530 results in a query from the MSC to SCP 2502. SCP 2502 then sends a request to ZLS server 2500. In response to the request, ZLS server 2500 determines whether or not the wireless call is within the subscriber's home zone. Along with this determination, ZLS server 2500 can also provide other information which may be used by the wireless service provider. In this example, ZLS sever 2500 also returns geographic information related to the zone, as described in more detail below.

According to known technology, whenever calls to or from a wireless telephone are being processed, the MSC can send a query to an SCP to receive call routing instructions or to implement special services, such as for example, call forwarding or call blocking, and the like. The query message sent from the MSC to the SCP typically includes information such as the calling party number, the called party number, the MIN, the MSC_ID and the Location_ID. In this example, the latter three pieces of information are used by the ZLS server to make its determination.

a. Decision Engine Architecture

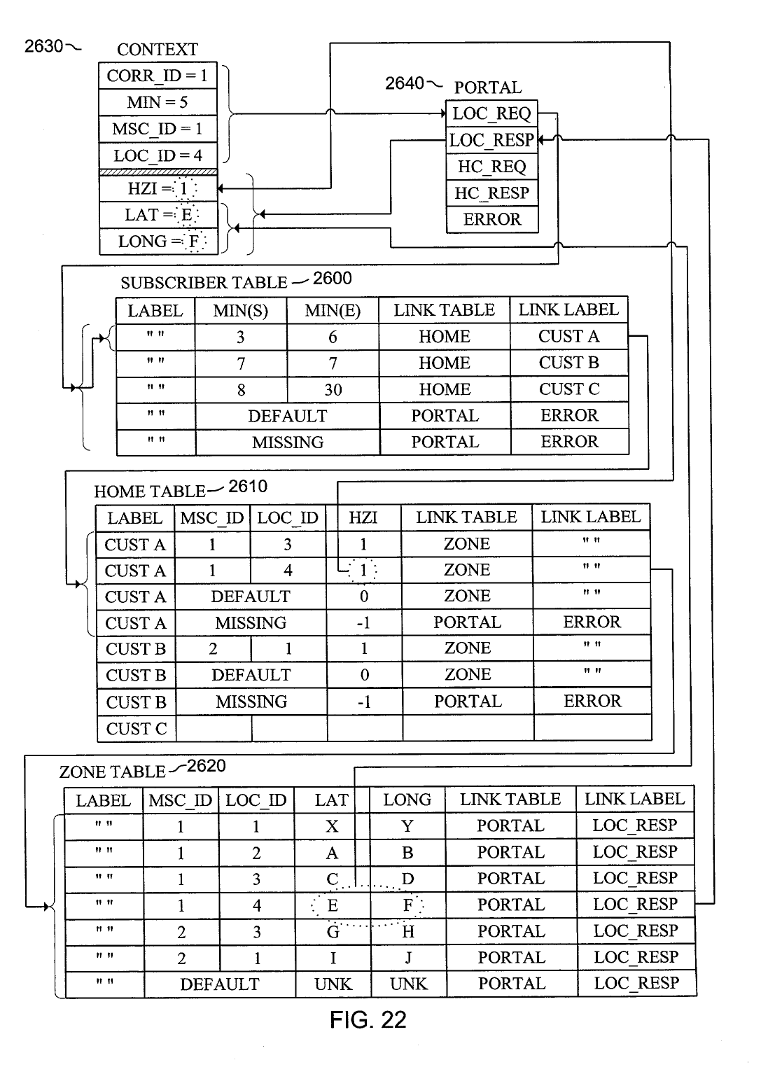

ZLS server 2500 comprises a decision engine according to the present invention. The decision engine architecture comprises a context and four tables as shown in FIG. 22. Each of the tables are described below.

Subscriber table 2600 includes the following columns: Label field, MIN start field, MIN end field, Link Table field and Link Label field, and is used to correlate a particular wireless telephone or a range of wireless telephones to a particular subscriber. By including both a MIN start field and a MIN end field, the ZLS can provide support for subscribers having multiple wireless telephones. For example, a large corporation or other entity may supply wireless telephones to its workforce. Preferably, the MINs assigned to this single entity's devices would comprise a contiguous block of numbers. In this case, a range of MINs can be used to identify all of the subscriber's telephones. The Label field of Subscriber table 2600 comprises blanks, or null values, “ ”. When a Label field is null, it indicates that any links to the table link to the entire table and the particular row sought is determined from criteria in the query. The Link Table field indicates that Home table 2610 is the next table forming the answer to the query. The Link Label field identifies the particular customer associated with the MIN of the wireless telephone. Accordingly, in table 2600, customer A owns wireless telephones having MINs 3-6, while customer B only owns a single wireless telephone having MIN 7, and customer C owns wireless telephones having MINs 8-30.

Home table 2610 includes the following columns: Label field, MSC_ID, Loc_ID, HZI field, Link Table field and Link Label field, and is used to correlate a particular subscriber to his home zones. Each subscriber corresponds to a partition in the table, i.e., a set of rows having a common label. Each row in a partition corresponds to a sector, and the HZI field indicates whether the sector in part of the subscriber's home zone. If the HZI value is “1” the sector is part of the subscriber's home zone, if it is “0” the sector is not part of the subscriber's home zone and if it is “−1” the ZLS cannot make a proper determination. As shown in table 2610, customer A has two sectors which comprise his home zone, i.e., sectors 3 and 4 served by MSC 2510, while customer B has only sector 1, served by MSC 2530 as a home zone.

As described earlier, the Default row within a partition is traversed whenever the query data does not match any of the keyed value or values in the partition. For example, in Table 2610, if the query comprises MSC_ID=1 and Location_ID=2, these values are not present for customer A. In this case, the Default row provides the Home_Zone_Indicator, HZI=0, which indicates that the wireless telephone is not being operated with customer A's home zone. Similarly, the Missing row is traversed whenever the keyed value is not provided. For example, if the query comprises MSC_ID=“ ”, and Location_ID=“ ”, the Missing row yields the result, HZI=−1, indicating that the ZLS cannot make a home zone determination.

After the HZI is determined, the query traverses the appropriate next table as indicated by the Link Table and Link Label fields. If determining the HZI were the only function of the ZLS, the Link Table would simply be the Portal table, and the query process would be complete. However, as described above, the ZLS server in this example provides further information related to the location of the wireless telephone. Accordingly, many of the rows include a Link Table value pointing to Zone table 2620.

Zone table 2620 is a keyed table and provides the latitude and longitude of a center point for each sector. For example, the center point 2520 for zone 1 in cell site 2522 has a latitude of X and longitude of “Y.” Similarly, center point 2550 for zone 1 in cell site 2542 has a latitude of “I” and a longitude of “J.” This geographic information is provided to the wireless service provider in along with the HZI in response to the query.

The structure and purpose of the Context 2530 and the final table, Portal table 2540 will be described in more detail in the next section.

3. ZLS-SCP Message Flow and Table Traversal

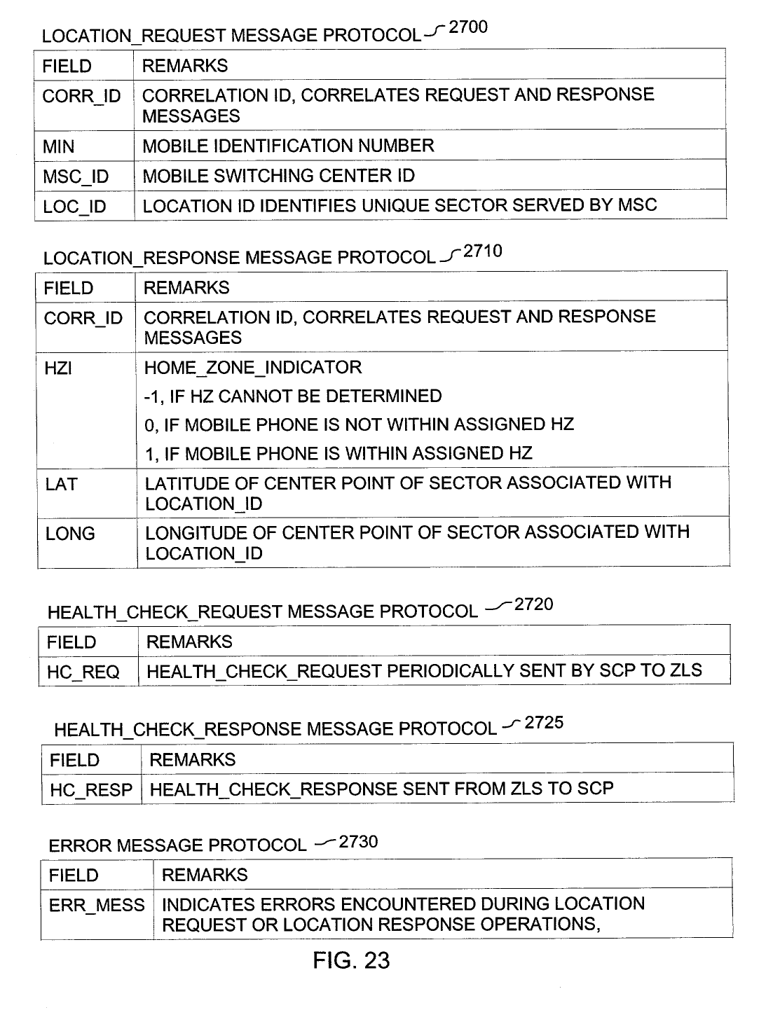

As described above, the MSCs send a query message to SCP 2502 which then queries ZLS server 2500. As described earlier, a decision engine can be configured to use many different application protocols which define the message syntax passed between it and other systems. In this example, the application protocol comprises five different messages that can be passed between SCP 2502 and ZLS server 2500. The messages and protocols are described in FIG. 23 as follows: Location Request message, described in protocol 2700, Location Response message, described in protocol 2710, Health_Check Request message, described in protocol 2720, Health_Check_Response message, described in protocol 2725, and Error_Message message, described in protocol 2730.

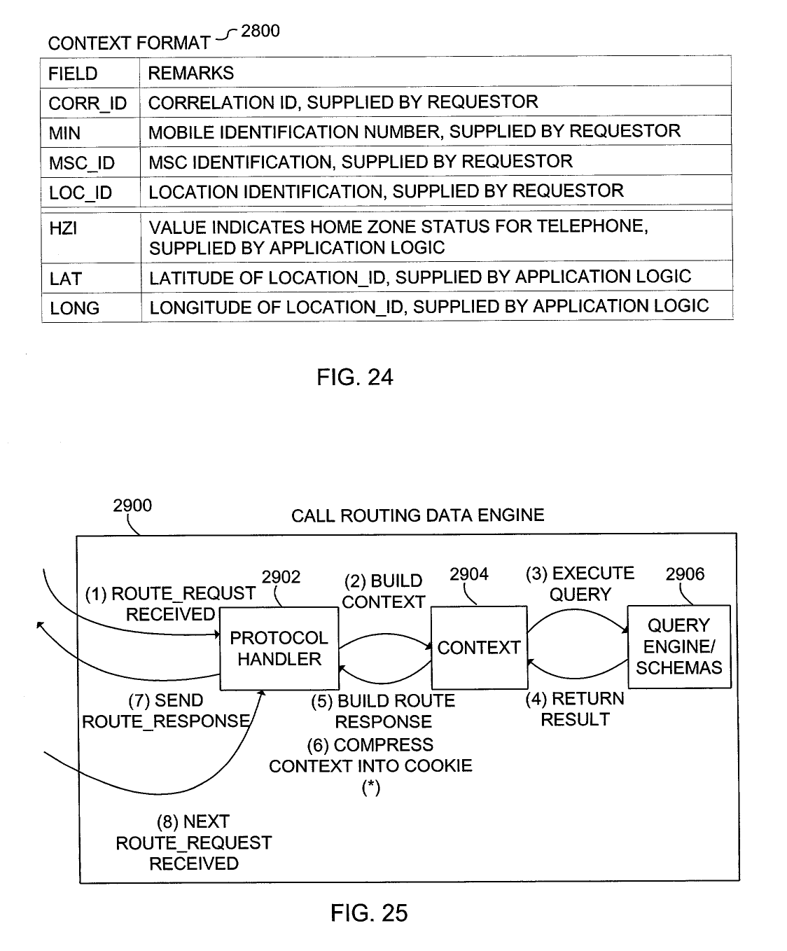

Context 2630 comprises the data actually passed between SCP 2502 and ZLS server 2500. In this example, the first four fields in Context 2630 comprise the input data, i.e., the data provided to the ZLS server. Context 2630 also comprises an input Message_Type field (not shown in FIG. 22) which, as described earlier, points to the corresponding row in Portal table 2640 (in this example, the input Message_Type is a “Location_Request” message). Data for these fields is provided to ZLS server 2500 in a Location_Request message according to the protocol shown in protocol 2700. For example, if a wireless subscriber is using his wireless telephone having a MIN of 5 within zone 4 of cell site 2524, the values passed from SCP 2502 may be as shown in Table 2630. This data is transmitted to Portal table 2640 where the query operation commences. Context 2800, in FIG. 24, provides a more detailed description of each data field in the Context.

Portal table 2640 comprises five rows, each corresponding to one of the message types, i.e., Location_Request, Location_Response, etc. As shown in FIG. 22, data from the input portion of Context 2630 is used by the query engine to execute the query. Location_Request row of Portal table 2710 comprises Link Table and Link Label values (not shown in FIG. 22) pointing to Subscriber table 2600 and a null label. Accordingly, in this case, the MIN provided in the query is used to identify the appropriate row in Subscriber table 2600. In this example, the query comprises MIN=5, which corresponds to the first row of the table because it falls within the range MIN(S)=3 and MIN(E)=6. This row is linked to the customer A label in the home table, as shown in FIG. 22.

Customer A has two sectors in its home zone and described above and shown in Home table 2610. In this example, the query data (in Context 2630) indicate that the MSC_ID=1 and the Location_ID=4. The corresponding row, indicates that this sector (i.e., the sector currently being used by the subscriber) is within the subscriber's home zone (HZI=1). As shown in FIG. 22, this value is written to an appropriate field in Context 2630. At the same time, the row in Home table 2610 is linked to a null label in Zone table 2620.

As described above, Zone table 2620 provides the geographic information associated with a sector. As shown in FIG. 22, for MSC_ID=1 and Locatio_ID=4, the latitude is “E” and the longitude is “F.” Again, these values are written in the appropriate field of Context 2630, as shown in FIG. 22.

Once the query engine is returned to portal table 2640, Context 2630 is updated to reflect an output Message_Type (not shown in FIG. 22) to indicate a Location_Response. Data from Context 2630 is sent by the protocol handler back to the SCP for further call processing.

By using a decision engine such as shown in FIGS. 21-24, a ZLS system can be implemented swiftly with minimal impact on the expensive SCP resources. Also, as shown in the example, the potential for adding additional data results of functionality to the ZLS is a simple as adding one or more tables, hard-wired into the decision engine. From a design and implementation standpoint, the ZLS server can be implemented in a matter of days rather than a matter of months as would be required using conventional database systems and architecture. Moreover, the decision engine in this example can issue query results with very high performance due to the hard linking between tables.

### EXAMPLE 2

### Decision Engine Solution for a Call-Routing System

Although decision engines according to the present invention are stateless, some applications may require use of a state. If state information is needed, a “cookie” approach can be implemented as described below. In this manner, the performance gain by not having to actively keep track of state information is extremely high and results in more simplicity during the application design process. According to the present invention, state information, if needed, is contained within the query itself.

This example, illustrates use of a decision engine to implement a call routing system. In the previous example the query and responses where stateless, i.e., queries are provided to the decision engine that are not related to any previous queries. In contrast, the queries presented to the decision engine in this example may be stateful. That is, in providing routing instructions in the PSTN, a query may be dependent on an earlier query, as described below. In any event, a decision engine according to the present invention can be used to provide an efficient solution to call routing problems.

In this example the call routing application accommodates many different events, such as screening/routing calls based on calling party number (CgPN) and called party number (CdPN), time of day, day of week, or holiday, providing random distribution of calls across the network, routing based on pre-determined capabilities, quality of service, and the like. The present example shows how a route request, sent from a service switching point (SSP) or an SCP to the decision engine, is processed and a route response is supplied back to the switch. On the telephony-side the query process is initiated by the SSP. In this example, the call routing decision engine only indicates the trunk that the switch should use to reach the next switch. When the call set up process reaches that next switch, may make a similar request to the call routing decision engine or to some other routing engine in the network.

FIG. 25 is a high-level schematic diagram showing the process flow for the application of the present example. In step (1) service logic on an SSP or SCP executes to generate a Route_Request (query) that is sent to call routing decision engine 2900. In step (2) protocol handler 2902 populates context 2904 with relevant information retrieved in the Route_Request message. In step (3) service logic in the query engine 2906 is executed to obtain a route result from the application schemas. In step (4) call routing instructions are written into the context according to the results determined by the query engine. In step (5) protocol handler 2902 generates a Route_Response message from data in context 2904. In step (6) protocol handler 2902 compressed context 2904 into a “cookie” which is inserted into the Route_Response message, prior to transmitting the message back to the SSP or SCP in step (7)

The cookie allows the call routing decision engine, which is a stateless system, to provide a “next route” if requested. As shown in FIG. 25, step (8) occurs if the SCP or SSP cannot use the route provided for some reason. Such a situation could occur, for example, if no circuits are available on the selected trunk. If step (8) is taken, the switch (or SCP) includes the cookie in its next request. The cookie is inserted into one of the many unused data fields available in a TCAP message (which would be the protocol for Route Request and Route_Response queries in this example). Accordingly, from the SSP's and SCP's point of view, handling of the cookie requires no additional programming, other than an instruction to pass the data along if a subsequent route request is necessary.

The context can be made into a cookie in any suitable fashion. For example, the context can be made into a cookie with or without compression. Because neither the SSP nor the SCP needs to read the cookie, the format of the cookie is not important to the present invention. As long as the call routing decision engine can reconstruct the context from the cookie, it will serve its purpose.

Accordingly, in step (9), when the call routing engine receives a cookie in a request, the it expands the context back out and uses the prior context information to locate the next table or next label. From this information, the call routing engine can go to the correct memory location to identify a new answer for the route request. By freezing the state of earlier context, and by sending the state back with the response, the call routing decision engine can very quickly get back to where it was in answering the request. That is, the call routing decision engine can move immediately to a route table and locate the next therein, which becomes the answer to the next route request. The call routing engine can then provide the answer in a Route_Response message.

In describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

The foregoing disclosure of the preferred embodiments of the present invention has been presented for purposes of illustration and description. It is not intended to be exhaustive or to limit the invention to the precise forms disclosed. Many variations and modifications of the embodiments described herein will be obvious to one of ordinary skill in the art in light of the above disclosure. The scope of the invention is to be defined only by the claims appended hereto, and by their equivalents.

What is claimed is:

1. A decision engine for servicing high-speed data queries comprising a kernel component; a schema plug-in object; a protocol plug-in object; and a transport plug-in object, wherein the objects are compiled to form an application adapted to receive a query message and to respond to the query message by traversing a plurality of tables defined in the schema plug-in object.

2. The decision engine of claim 1, further comprising a replication object, wherein the replication object comprises logic for implementing clusters of decision engines.
